(19) United States
(12) Patent Application Publication
(10) Pub. No.: US 2013/0227286 A1
(43) Pub. Date: Aug. 29, 2013

(54) Dynamic Identity Verification and Authentication, Dynamic Distributed Key Infrastructures, Dynamic Distributed Key Systems and Method for Identity Management, Authentication Servers, Data Security and Preventing Man-in-the-Middle Attacks, Side Channel Attacks, Botnet Attacks, and Credit Card and Financial Transaction Fraud, Mitigating Biometric False Positives and False Negatives, and Controlling Life of Accessible Data in the Cloud

(71) Applicant: Andre Jacques Brisson, Vancouver (CA)

(72) Inventor: Andre Jacques Brisson, Vancouver (CA)

(21) Appl. No.: 13/764,586

(22) Filed: Feb. 11, 2013

Related U.S. Application Data
(63) Continuation-in-part of application No. 12/297,884, filed on Nov. 19, 2008.
(60) Provisional application No. 60/794,522, filed on Apr. 25, 2006.
(60) Provisional application No. 60/803,930, filed on Jun. 5, 2006.

(51) Int. Cl. H04L 29/06

(52) U.S. Cl. CPC H04L 63/08
USPC 713/168

(57) ABSTRACT

A method of sending a secure encrypted communication between a first source computer and a second destination computer involves providing the source and destination computers each with an identical copy of a unique pre-distributed symmetric key and a first valid offset. The destination computer sends the source computer a random, previously unused token of variable length from the pre-distributed key beginning at the destination computer's last valid offset. The source computer generates the corresponding token from its last valid offset for the corresponding key in respect of the destination computer. If the source authenticates the destination computer, the source and destination computers update their offsets independently and a communication is sent encrypted by the pre-distributed key.

### CROSS-REFERENCE TO RELATED APPLICATIONS

This application is a continuation-in-part of application Ser. No. 12/297,884 filed Nov. 19, 2008 entitled “Dynamic Distributed Key System and Method for Identity Management, Authentication Servers, Data Security and Preventing Man-in-the-Middle Attacks” which is pending.

### TECHNICAL FIELD

The invention relates to the field of security for electronic communications and in particular network scaling, authentication and Identity Management, detection, revocation and encryption methods, intrusion detection, signature, non-repudiation, authorization, digital rights management, provenance and key related network security functions.

### BACKGROUND

The most widely used method for providing security online for authentication and encryption is using asymmetrical encryption systems of the public key design where authentication relies on certificates issued by certificate servers. Public Key Infrastructure (PKI) systems have known security vulnerabilities such as being susceptible to Man-in-the-Middle [MitM] attacks, because they are often implemented improperly and because public keys are always available for factoring and because there is always key transfer to initiate a session.

The overhead of the PKI system is high, not just because of all the steps involved in the architecture, but also their choice of cryptography. The key strengths used by the PKI have been called into question recently. Public keys are compound primes and they are always available for attack. There have been significant strides in prime numbers and factoring theory. New techniques exist to factor compound primes. Fast computers factor compound primes by simplified techniques like the “sieve” method, so what used to take years now can be done in hours. Using progressively stronger keys with public key systems becomes progressively more difficult because of the additional computational overhead introduced as keys get stronger (longer). Additionally, with the advent of quantum computing all public keys will be easily factored and broken because of fixed key sizes.

There are a number of additional reasons why security on public key systems is problematic. The Certificate Authority [CA] may not be trustworthy. The private key on a computer may not be protected. It is difficult to revoke keys (refuse network access). Revocation generally requires Third Party intervention. Asymmetric systems are difficult for the average user to understand. Also the cryptographic key information is publicly available to hackers. There are currently no methods of providing continuous, stateful authentication, continuous stateful intrusion detection and automatic denial of network access to hacking and spoofing.

A distributed Identity Management key is a key that usually has been pre-distributed and pre-authenticated by some manual means, such as courier or person to person, to the party involved. This is the most secure method of ensuring key privacy; however this is a problem when users (persons or non-person entities) are remote or mobile and when new dynamic sessions wish to be established with parties who do not have pre-shared key information. Dynamic Identity Verification and Authentication (DIVA) enables the secure distribution of keys electronically and will catch any attempt to use a captured or impersonated key.

Any topology or technologies created to provide the highest level of network security must address issues of secure key management, key creation, key exchange, authentication, intrusion detection, revocation and authorizations.

There is a need for a key based network security control, protocol, process and framework where there is never any transfer of key or offset information during sessions, after one-time pre-distribution and pre-authentication of users and endpoints following accepted identity proofing techniques for person and non-person entities. There is a need for a system where there is never a shared secret transmitted in session, where there is never a public key which can be factored or broken because of improved factoring techniques or quantum computing, and where there is no reliance on asymmetric key exchange or negotiation which always has security flaws if used in isolation.

There is a need to prevent credit card, debit card, and financial online, electronic fraud as well as preventing the theft or transmission key and PIN information. There is a need for security controls, protocols, and frameworks that overcome the fatal security flaws attendant with asymmetric and public key infrastructure key exchange and topology. There is a need for key based identity management for person and non-person devices (communication backbone and endpoint devices) that comprise our communication networks, smart grids and critical infrastructures. There is a need for protocols and network configurations that eliminate threats such as man-in-the-middle attacks, side channel attacks, botnet attacks, and the unlimited accessible life of data residing in the “cloud” or on the internet.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

A dynamic distributed key, identity management system is provided in which a key structure storage authentication server manages pre-distributed and pre-authenticated private keys and compares dynamic offsets without key or offset exchange after initial key provisioning. In distributed key systems the server has identical copies of all the keys and key structures that are pre-authenticated and pre-distributed to any end points on a network and link keys are pre-authenticated and pre-distributed to any other server to create a “network of secure networks”. Each endpoint has a unique distributed private key. Thereafter there is no subsequent transfer of key or offset information in session which eliminates man-in-the-middle attacks. Side Channel attacks are prevented because all operations after key load are order 1 operations when Whitenoise SuperKeys are used. These distributed keys can in turn generate and distribute more keys safely following prescribed methodologies.

Initial key distribution can be conducted in traditional physical manners. One time key distribution and provisioning can be done electronically because any key theft, if possible, cannot happen without being detected by dynamic identity verification and authentication. Furthermore, system keys are inherent and compiled within both client and server software to further protect this initial, one-time key distribution by sending them encrypted. Any use of asymmetric techniques for key exchange is not a requisite for security. However, DIVA and DDKI technologies can work in concert with asymmetric approaches and topologies where those approaches are relegated to being additional authentication factors or security controls so that existing system security controls don't have to be changed or removed in transitioning network security to incorporate DDKI frameworks and DIVA protocol. Use of other security techniques for initial electronic provisioning of pre-authenticated and pre-distributed keys simply adds additional hardening of initial, one-time key distribution and may simply engender more confidence. Because dynamic distributed key frameworks can be used with any other security controls or frameworks there is an expanded range of secure system and communication configurations.

Dynamic distributed key infrastructures are network frameworks of servers and any form of communication endpoints that utilize the dynamic identity verification and authentication process. The dynamic identity verification and authentication process is a key based security protocol that can be used for any key based network security controls including, but not limited to secure network access, identity management, continuous and dynamic authentication, authorization, inherent intrusion detection, automatic revocation, signatures, non-repudiation, and digital rights management. This is possible because exponential key structures create key streams of extraordinary length that can easily outlive the expected life of any person or non-person entity without ever using any key segment or token more than once. Because the keys are so large, and because the system manages offsets within the resultant key stream it is possible to use different portions of the key stream, tracked by their offsets for additional security controls like digital signatures, non-repudiation and any other key based network security control.

In particular, the invention provides for simple and interoperable network scaling, dynamic authentication with non-factorable, exponential (deterministic, random key streams of extraordinary length that require the storage of only a small amount of key structure information), one-time-pad based Identity Management keys, inherent intrusion detection, revocation, signature, non-repudiation, authorization, digital rights management, provenance and any other key related network security function with a single key. This can include encryption methods but anticipates using standardized ISO-IEC modules for encryption. Security is accomplished using a method where there is NO asymmetric key exchange (or negotiation) and therefore this prevents man-in-the-middle attacks. Side Channel attacks are prevented because after exponential key set up all operations are order 1 so there are no discernible output patterns to use for cryptanalysis. Botnets are thwarted by using DIVA to authenticate outbound communications. The unlimited life of data residing in the “cloud” is managed by providing unilateral, robust endpoint encryption using approved encryption algorithms in conjunction with exponential keys or an appropriate symmetric key. As opposed to constructing a bi-lateral configuration where both a server and an endpoint have identical, pre-distributed and pre-authenticated key structures, only the endpoint will have the key. As opposed to attempting to delete data that resides “in the cloud” the data resides in the cloud in an encrypted state and only the endpoint and legitimate owner of the data has a key for encryption and decryption of the data in the cloud. Use of this invention may provide interoperability, simple scalability, and flexibility in configuration. Point-to-point and single endpoint configurations enable specific security outcomes like mitigating Botnets, securing communications through the “cloud” or internet, or securing private information stored within the “cloud” because of offset management.

Dynamic Distributed Key Infrastructures (DDKI) as described herein address the aforementioned elements and shortcomings of the PKI system. At the topological level, several network topologies are disclosed that use distributed keys as a random number generator to in turn generate additional distributed keys and securely distribute them to additional devices/persons electronically for easily scalable networks and for scaling secure networks over the Internet. Additionally, these distributed keys can generate session keys for use with any encryption algorithm and do so without any asymmetric key exchange or negotiation. Although the preferred embodiment uses exponential, one-time-pad keys for additional key generation (and for all security functions including encryption), the encryption function may be accomplished with any deterministic random (pseudo random) data source and any encryption algorithms. Adoption of secure network topologies also relies in some contexts on its ability to leverage existing technologies. As such, a hybrid approach is disclosed that uses the Internet's Secure Socket Layer public key technology to add another layer of abstraction for an electronic, one-time key distribution to prevent Man-in-the-Middle attacks. It creates a two-channel authentication scheme. In this context, two channel authentications refer to the combined use of symmetric and asymmetric techniques for on-line enrollment, key distribution and activation of the key and account. The use of any existing asymmetric security techniques is not required for fundamental communications security but rather adds a level of security confidence and expanded network configurability for those familiar and reliant with those security techniques. Additional security controls are not required for key distribution because keys are distributed in an encrypted state using a system key, or multiply encrypted using the system (application) key and any other predistributed endpoint key.

Just as an automobile requires many different technological components working in harmony, secure networks require several components for effective and secure use and deployment. Disclosed are techniques to provide stateful and continuous authentication, detection and automatic revocation. These components are based on the ability to use a deterministic random (pseudorandom) data source as a one time pad to generate and compare portions of a key stream (key output) that have not yet been created and not yet transmitted. Key segments are compared ahead in the key stream. Secure transmission of keys occurs if they are delivered in an encrypted state and an un-authorized party never has access to all the information required to fashion a break or a successful guess of a key stream segment. This also requires the ability to easily manage offsets so each endpoint knows where in the key to begin key stream segment (token) generation. Management of dynamic offsets or indexes into an identity management key stream means that there is no key or offset information transmitted during a session (or any time after initial key distribution by Level 3 or 4 Identity proofing for person or non-person entities).

Effective techniques exploiting these characteristics of Dynamic Distributed Key topologies are provided to prevent Man-in-the-Middle attacks, provide continuous authentication and detection, and safeguard with automatic revocation. This invention uses a distributed key, not as a key for a point-to-point link or encryption, as would traditionally be done. Instead the key is used to authenticate network access and use, assign provenance to network use and data, and index and log all network or application access and use.

Additionally, in one hybrid configuration that distributed identity management key can be used as a random number generator to create and secure AES session keys without using any public key exchange method to do so. In this instance, the distributed DIVA key is used to create session keys for an approved AES or other encryption module that resides at the endpoint with DIVA to create secure links of communication. Distributed keys by their nature allow the authentication and identification of the parties. This is an advantage over the PKI, public key infrastructure, system.

Basic DIVA DDKI topology: DIVA and DDKI readily facilitates secure encrypted, authenticated communications between different independent, secure networks by utilizing pre-distributed and pre-authenticated network link keys without ever transferring or sharing any private account or client keys. End user keys and network link keys are deployed at two distinct hierarchical levels in a DDKI framework. The flow:
i) Sender encrypts data/file to send to a user in an outside network.
ii) The file goes to the network server where it is trans-encrypted from the Sender private key to the network link key. The link keys between networks are pre-distributed and pre-authenticated and are secret themselves.
iii) The server sends the encrypted data/file to an external network which confirms authorization for the intended recipient. The receiving server transcripts the file data from the shared server link key into the private key of the intended receiver.

Because of the speed of the keys there is no appreciable overhead with the extra step. An encrypted file has been sent from one secure network to another without sharing private keys. This eliminates fear of data sharing and data misuse between departments. Everything is secure and logged. It facilitates secure 1:1 and 1: many communications. A file can be sent from one point with a single click to thousands of locations and the data will arrive at each endpoint encrypted in their own unique private key. Networks are fragmented because of the limitations of competitive technologies that create gaps in overall network security because of poor interoperability, scalability and accuracy.

The invention provides therefore a method of sending a secure encrypted communication between a first source computer and a second destination computer, comprising the following steps:

i) providing the source and destination computers each with an identical copy of a unique pre-distributed symmetric key and a first valid offset;
ii) the source computer sending a request to the destination computer to identity itself, without sending either an offset or a key with the authentication request;
iii) the destination computer responding by sending the source computer a random or highly pseudo-random, previously unused token of variable length from the pre-distributed key beginning at the destination computer's last valid offset;
iv) the source computer receiving the token and generating the corresponding token from its last valid offset for the corresponding key in respect of the destination computer;
v) the source computer comparing the two tokens bit-by-bit and if they are identical, authenticating the destination computer, and if they are not identical, cancelling the session;
vi) if the source computer finds the tokens to be identical, the source computer sending an authorization to the destination computer to continue, without including an offset or key with said authorization;
vii) the source and destination computers updating their offsets independently by advancing the offset by the length of the last token and a number calculated by a predetermined function;
viii) a first one of said source or destination computer sending a communication to the other one of said destination or source computers respectively, encrypted by the pre-distributed key and the other one of the source or destination computers decrypting said communication using said pre-distributed key;
ix) repeating steps ii) through viii) for subsequent communications between the source computer and the destination computer.

Dynamic Distributed Key Infrastructures (DDKI) frameworks are tiered, hierarchical, secure, network-of-networks of persons, devices, servers and networks of dynamic identity verification and authentication (DIVA) enabled communicants. Master Keys (which create an infinite number of unique Identity Management keys) can be distributed to telecommunication and service providers.

Master Keys can be distributed directly to telecommunication providers following regulatory protocols. Carriers create their own keys internally. Carriers in turn can provide keys to service providers, enterprises and consumers (subkeys of the master key). Enterprises create keys internally for their own employees or clients. Link keys between carriers and between enterprises create a secure network-of-networks necessary for vast area communication architectures. See FIG. 13. This tiered distribution approach facilitates secure networks while balancing privacy and legitimate law enforcement needs. It does not require any asymmetrical key creation or asymmetrical key (PKI) key distribution techniques.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 illustrates the prior art PKI system;

FIG. 2 illustrates possible configurations that could use the invention's secure communication links using traditional computing networks;

FIG. 3 is a schematic diagram illustrating the system of the invention;

FIG. 4 is a flowchart illustrating one component of the process;

FIG. 5 is a flowchart illustrating a second component of the process;

FIG. 6 is a class diagram for one component of the process;

FIG. 7 is a class diagram for a second component of the process;

FIG. 8 is a schematic illustration of a packet which is wrapped according to the process;

FIG. 9 is a schematic illustration of a header according to the process;

FIG. 10 is a flowchart illustrating a hybrid AES-Whitenoise process;

FIG. 11 is a schematic illustration of the authentication and identity management configurations according to the process; and

FIG. 12 is a schematic illustration of the method of key creation by perturbing a key schedule.

FIG. 13 is a schematic illustration of a dynamic distributed key architecture or framework that is tiered, hierarchical, easily scalable and interoperable.

FIG. 14 is an illustration of an authentication token being created and sent to a server for comparison and upon successful authentication how each endpoint independently updates the current dynamic offset without sending any key or offset information.

FIG. 15 is a schematic illustration of a configuration of DIVA where data both entering and leaving a computer are authenticated in order to prevent botnets.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

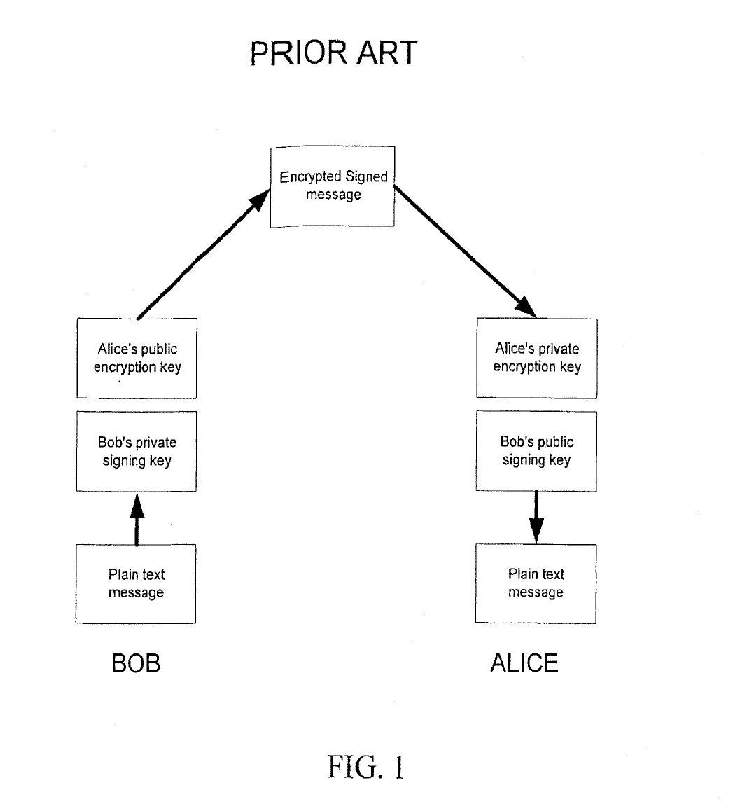

FIG. 1 illustrates the existing public key asymmetric encryption method of encrypting communications between Bob and Alice, which is the most widely used method currently for providing security online for authentication and encryption.

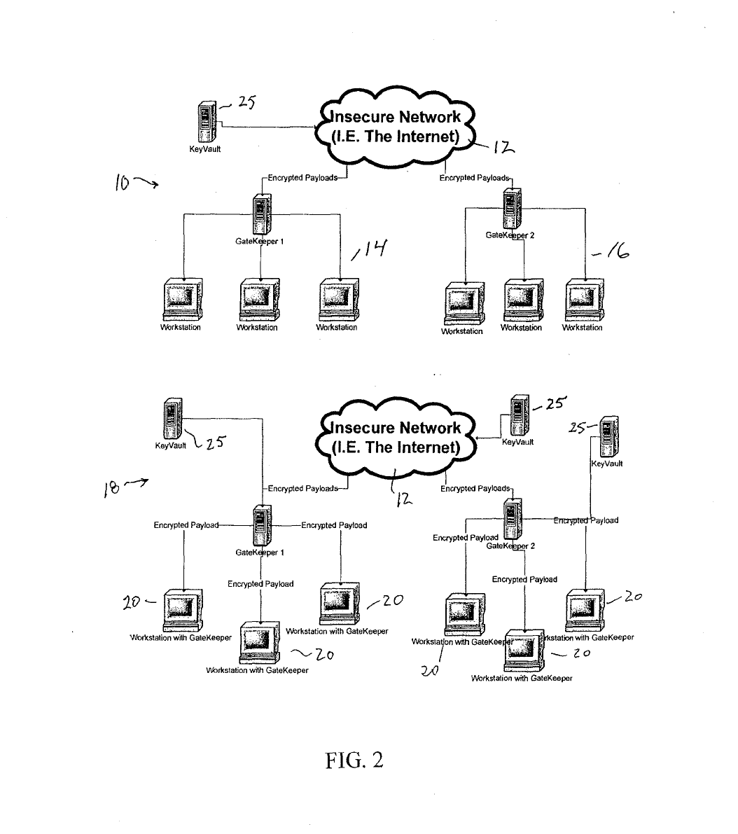

FIG. 2 illustrates possible configurations that could use the present invention's secure communication links using traditional computing networks. In arrangement 10, all data sent over the Internet 12 between networks 14 and 16 is encrypted In arrangement 18, all data sent between any workstation with Gatekeeper nodes 20 is encrypted.

In what follows, the two components of the invention are referred to as GateKeeper and KeyVault. GateKeeper is the point to point data link layer tunneling system which uses KeyVault. KeyVault provides keys to GateKeepers as they request them.

The GateKeeper and KeyVault servers can be used in any tier of network “architectures traveling from IP to IP, whether from computer to computer, or alternatively, from network to network, or computer to network, and wired-to-wired, wireless-to-wired, and wireless-to-wireless. The system is able to plug anywhere into a network because the system relies on the data link layer between systems. Some other encryption systems rely on the application level (SSH is an example of this). When the application level is used, the secure tunnel is application specific and needs to be re-integrated with each application that wishes to utilize it such as VOIP, e-mail, or web surfing. Using the datalink layer instead, allows immediate integration with every IP based application with no delay. The applications do not know that the tunnel is there.

The KeyVault, and the GateKeeper applications can work separately, or as a combination. The GateKeeper tunneling system can be used on its own to only facilitate the traditional notion of static point-to-point tunnels that would be useful for ISPs, governments, embassies, or corporations. The KeyVault architecture to distribute session keys based on a distributed key allowing for point-to-point dynamic connections can be applied on other areas apart from the tunnel. These other areas include cell phones to secure calls; e-mail systems to secure and authenticate e-mails; satellites for military satellite image streaming; peer-to-peer networks like Bit Torrent (many ISPs filter peer-to-peer network traffic and give users a slower throughput on those connections; encrypted traffic however cannot be analyzed).

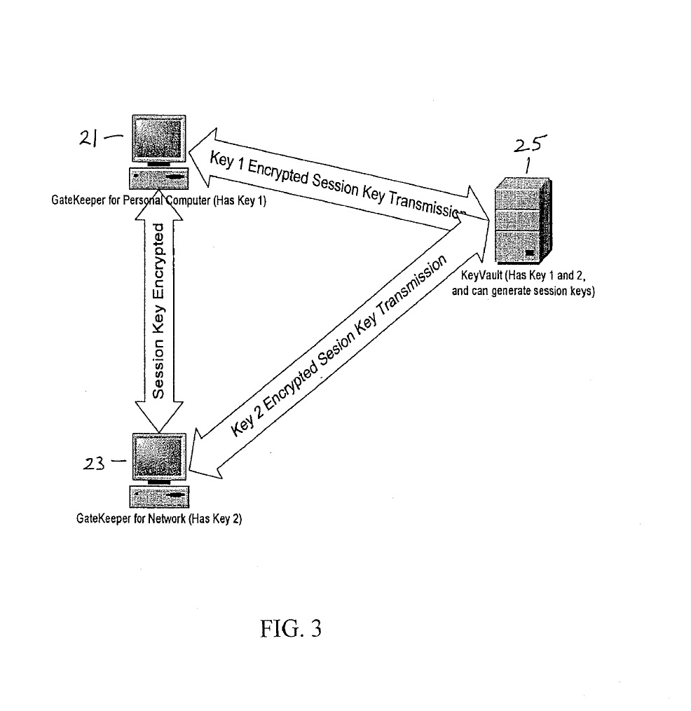

FIG. 3 illustrates schematically the system. Each GateKeeper workstation 21, 23 has a unique key-pairing with its Key Vault 25. The two GateKeepers 21, 23 request a session key from the KeyVault using their assigned keys which are assigned physically on installation. They can then communicate with each other using that session key. No single GateKeeper can decrypt arbitrary data. When encrypted data needs to be decrypted, only the destination computer can decrypt it, since only the two computers involved in the transmission can obtain the session keys from the KeyVault since the session keys are encrypted by a unique key pairing with the KeyVault.

The GateKeeper client creates and encrypts the request for the session key with the other GateKeeper with its private distributed key that only the KeyVault that holds the session key has a copy of. Only the two GateKeepers involved in the session can request the session key, as their private keys authenticate their requests with the KeyVault.

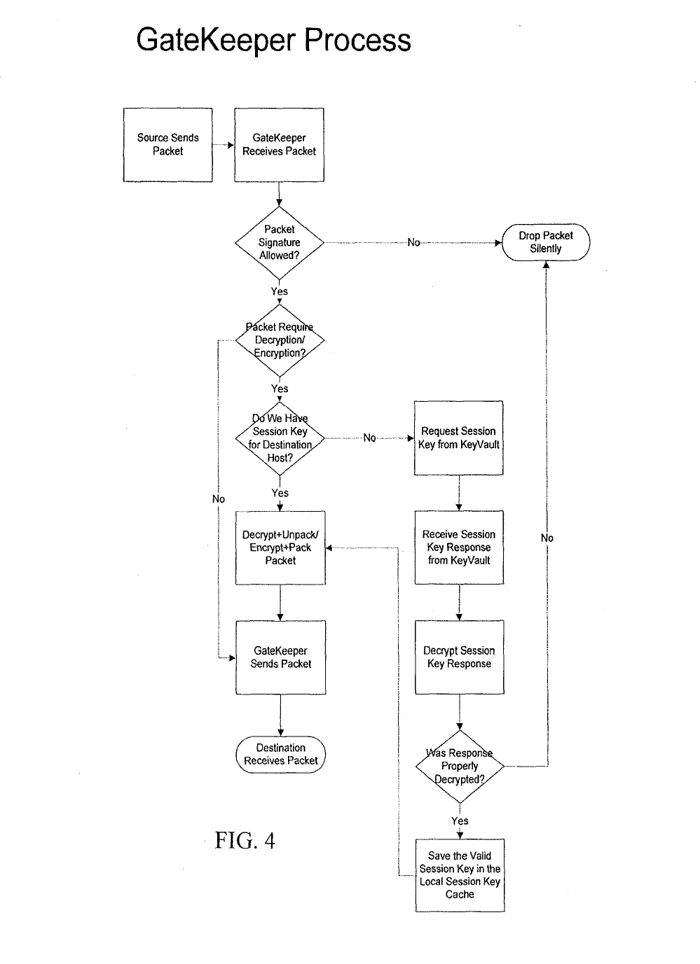

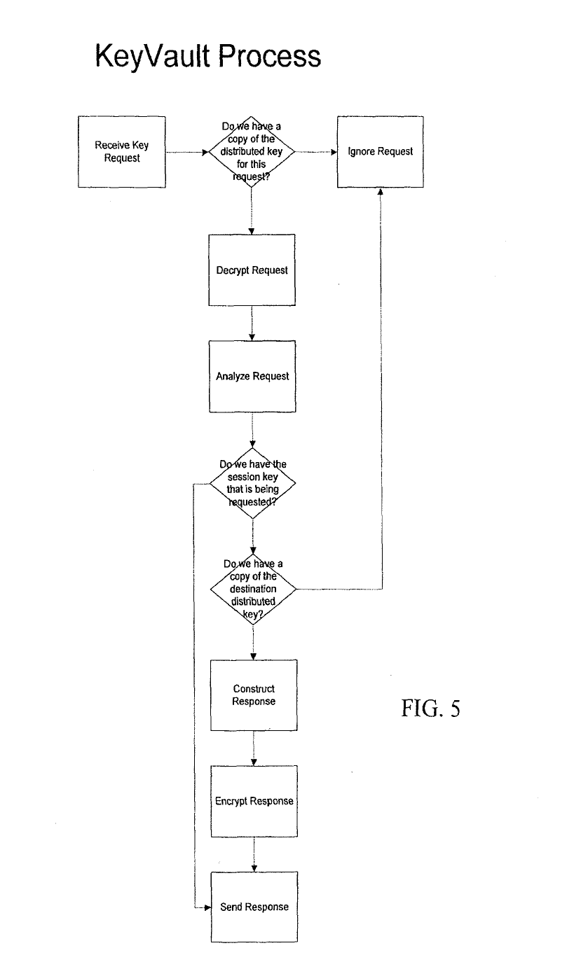

The sequences of events that drive a secure link start with the GateKeeper on the initiating side, move on to the KeyVault, and finally end at the receiving side. This can be seen in FIGS. 4 and 5. As seen in FIGS. 4 and 5 detailing the flow of events, in both the GateKeeper and the KeyVault, the two systems work together to form the distributed key system in establishing secure point-to-point communication. The GateKeeper communicates through tunnels to other GateKeepers using existing cached keys, and retrieves any needed session keys from the KeyVault as needed. The KeyVault simply receives and respond to key requests.

With reference to FIGS. 3, 4 and 5, a source Gatekeeper 21 has a private distributed key 1 which is associated with its unique identifier and stored at the KeyVault 25 in connection with that identifier. To commence an encrypted communication with Gatekeeper 23, Gatekeeper 21 sends a request to KeyVault 25 for a session key. KeyVault 25 identifies the sending GateKeeper 21 and locates its associated distributed Key 1. It then generates a unique session key for the session in question, identified by a unique session identifier. It then encrypts the session key with Key 1 and sends it, with the session identifier, to Gatekeeper 21. The source gatekeeper 21 then uses Key 1 to decrypt the session key and uses the session key to encrypt the communication, which is sent to Gatekeeper 23. Gatekeeper 23 receives the packet and determines whether it requires decryption. If it does, it communicates a request to KeyVault 25 for the session key. KeyVault 25 determines from the session identifier whether it has the corresponding session key, and whether it has GateKeeper 23's distributed key 2. If it does, it encrypts the session key using Key 2 and communicates it to GateKeeper 23. GateKeeper 23 then decrypts the session key using its distributed Key 2 and decrypts the communication from GateKeeper 21 using the decrypted session key.

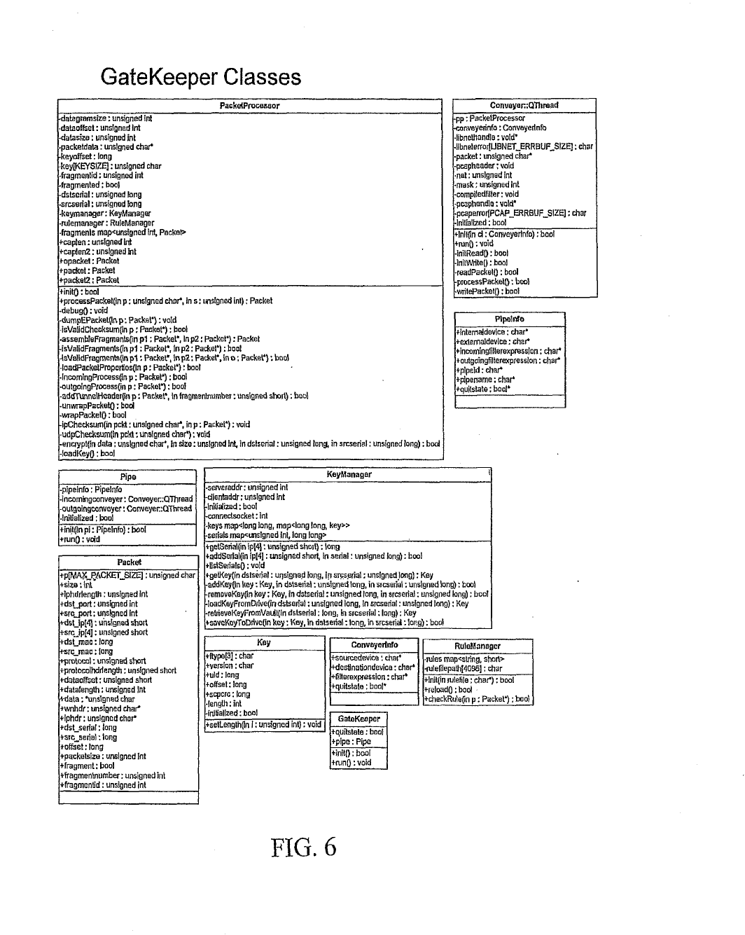

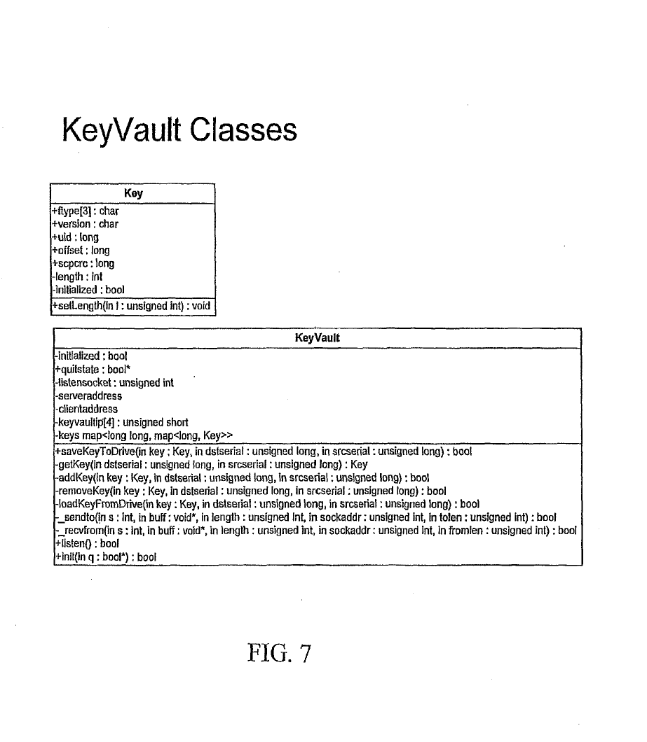

The GateKeeper Class Diagram is shown in FIG. 6. The Gatekeeper application may consist of one or more pipes, each pipe consists of an incoming and outgoing packet conveyor that is responsible for filtering and encrypting the packets based on the rules from the rule manager in their packet processor, retrieving keys as necessary through the key manager. The KeyVault Class Diagram is shown in FIG. 7. The KeyVault application has one main loop that listens for incoming key requests, and fulfills the requests with key responses.

When writing packets, the functions are ordinarily not available unless one initializes libnet in advanced mode as such:

libnethandle=libnet_init(LIBNET_LINK_ADV, conveyerinfo.destinationdevice, libneterror);

As can be seen in the code above, the defined value for LIBNET_LINK_ADV is used to initialize the libnet handle in advanced mode and on the datalink layer.

Also when reading packets, the types of packets read back are determined by a compiled “netfilter” style expression.

pcap_lookupnet(conveyerinfo.sourcedevice, &net, &mask, pcaperror);
pcap_compile(pcaphandle, &compiledfilter,
conveyerinfo.filterexpression, 0, net);
pcap_setfilter(pcaphandle, &compiledfilter);

As seen by the code above, a handle to a device one wants to read from, compile, and assign a filter to be used is opened up. This is where one integrates the system with IPTables firewall rules. One could for example ignore any traffic that is on ports 21 and 20 to block common ftp services.

In the PacketProcessor class is where the actual encryption key (“Whitenoise”) header gets appended to the end of the “wrapped” packet. By “wrapped” is meant that the original packet has been re-encapsulated ready to be encrypted. This encapsulation is the purpose of using a tunnel since encapsulated can be mangled by encryption without making the packet useless in teens of routing.

// create a UDP headers
*((unsigned short*)(packet.iphdr + packet.iphdrlength)) =
htons(TUNNEL_PORT);

// src prt

| *((unsigned short*)(packet.iphdr + packet.iphdrlength + 2)) = | |
|---|---|
| htons(TUNNEL_PORT); | // dst prt |

| *((unsigned short*)(packet.iphdr + packet.iphdrlength + 4)) = | |
|---|---|
| htons(UDP_HEADER_SIZE + datalength1); // lngth | |
| udpChecksum(packet.p); | |
| *((unsigned short*)(packet2.iphdr + packet2.iphdrlength)) = | |
| htons(TUNNEL_PORT); | // src prt |

| *((unsigned short*)(packet2.iphdr + packet2.iphdrlength + 2)) = | |
|---|---|
| htons(TUNNEL_PORT); | // dst prt |

*((unsigned short*)(packet2.iphdr + packet2.iphdrlength + 4)) =
htons(UDP_HEADER_SIZE + datalength2); // lngth

udpChecksum(packet2.p) ;

The above code shows where the custom-made UDP header gets created to use in the new encapsulated packet. There is a call made to the host to network byte order changing function for short data types, “htons,” for the entire information pact into the header bit by bit.

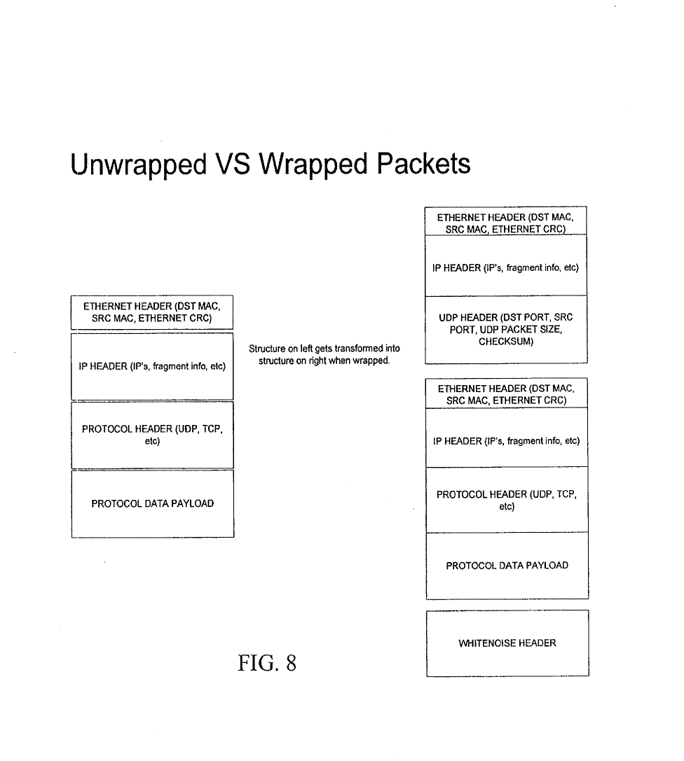

The actual composition of the encapsulated packet is shown in FIG. 8. Once the packet has been encapsulated into the new packet with the Whitenoise (WN) header, the embedded packet can be encrypted with the appropriate session key.

The reasons UDP packets were chosen to encapsulate the encrypted traffic are twofold. UDP is the only common protocol that includes the data size in the protocol, thereby allowing additional headers to be appended. Since this is a tunnel protocol, if any re-transmission of data is required, the clients can request it, and it is not needed for the Tunnel to keep track of lost data.

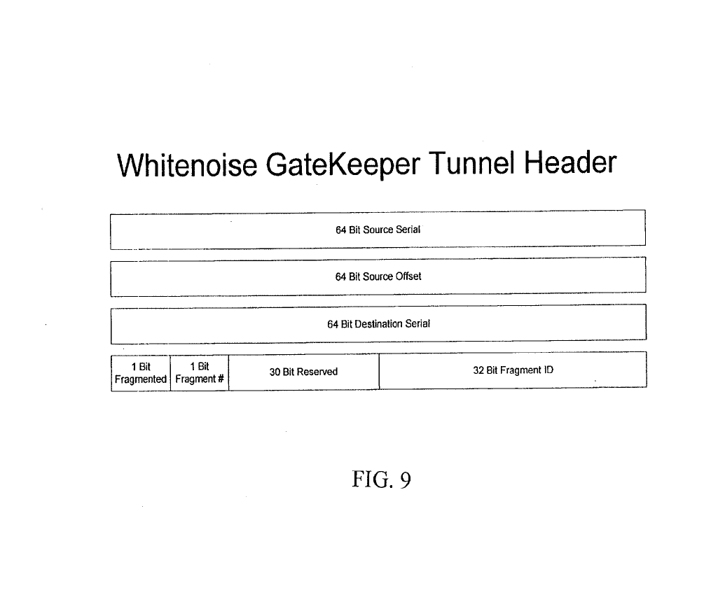

The Whitenoise header, shown in FIG. 9, consists of information to use the encryption, and some information regarding fragmentation for when the tunnel needs to fragment the data packets due to the MTU (Maximum Transfer Unit) being exceeded. The first serial is the serial of the originating system, the second serial is the destination system serial, and the offset is the offset into the Whitenoise cypher stream that was used to encrypt this particular packet. The fragmented bit indicates if this is a fragmented tunnel packet, the 1 bit fragment number indicates if it is the first or second fragment, 30 bits have been reserved for an authentication pad and 32 bits are used for the fragment id used to distinguish these fragments to other fragments. There is a 1 in 2³² chance that fragments may have overlapping fragment ids and this would corrupt the re-assembly. This header, consisting of 256 Bits, plus the additional Ethernet, IP, and protocol headers, in the encapsulated packet, make up the overhead in the overall tunnel system. This overhead is per packet, so if many small packets are sent out, then the percentage overhead is relatively large, however if large packets from file transfers are used then the overhead is very low.

In the following output from the GateKeeper application, the tunnel packet fragmentation is shown. A packet that is too large to be transmitted after the Whitenoise header is added to the packet, is split into two fragments. Each fragment maintains the original IP header as to make sure the packet gets delivered properly, and has fragmentation information in the Whitenoise header.

GateKeeper::init( );
Pipe::init( ); 1
Conveyer:initread( ) ether src not 00:00:00:21:a0:1a and ether
src not 00:04:E2:D7:32:9C
Conveyer::initwrite( )
KeyManager initializing
Conveyer:initread( ) ether src 00:00:00:21:a0:1a
Conveyer::initwrite( )
KeyManager initializing

incomingconveyer.init( ); 1
outgoingconveyer.init( ); 1

GateKeeper::run( );
Pipe::run( );
Outgoing: Fragmentation = TRUE copying ip and ethernet headers
setting new sizes
splitting up packet into fragments
adding 0xA to wnhdr
adding 0x8 to wnhdr
encrypting data sections of the two fragments
fragment checksums
done creating fragments

display fragment 1:

| 00 04 e2 d7 32 9d 00 00 | |
|---|---|
| 00 21 a0 1a 08 00 45 00 | |
| 03 17 ae 40 40 00 40 11 | |
| 06 39 c0 a8 01 08 c0 a8 | |
| 01 04 26 19 26 19 02 e3 | |
| 00 00 00 4d 00 61 00 74 | |
| 00 74 00 65 00 72 00 73 | |
| 00 2e 00 6d 00 70 00 33 | |
| 00 74 00 00 00 00 00 00 | |
| 00 00 6a 8e 79 91 cb c5 | |
| 01 00 6a 8e 79 91 cb c5 | |
| 01 00 da c3 5e 2f d5 c5 | |
| 01 00 da c3 5e 2f d5 c5 | |
| 01 00 00 00 00 00 00 00 | |
| 00 00 00 10 00 00 00 00 | |
| 00 10 00 00 00 16 00 00 | |
| 00 00 00 00 00 10 00 47 | |
| 00 34 00 37 00 4e 00 4f | |
| 00 56 00 7e 00 56 00 00 | |
| 00 00 00 00 00 00 00 67 | |
| 00 63 00 6f 00 6e 00 66 | |
| 00 64 00 2d 00 72 00 6f | |
| 00 6f 00 74 00 7c 00 00 | |
| 00 00 00 00 00 80 e2 a0 | |
| 94 75 a3 c5 01 80 e2 a0 | |
| 94 75 a3 c5 01 80 e2 a0 | |
| 94 75 a3 c5 01 80 e2 a0 | |
| 94 75 a3 c5 01 00 00 00 | |
| 00 00 00 00 00 00 00 10 | |
| 00 00 00 00 00 10 00 00 | |
| 00 1c 00 00 00 00 00 00 | |
| 00 10 00 4b 00 42 00 35 | |
| 00 43 00 34 00 31 00 7e | |
| 00 4a 00 00 00 00 00 00 | |
| 00 00 00 6b 00 65 00 79 | |
| 00 72 00 69 00 6e 00 67 | |
| 00 2d 00 77 00 32 00 37 | |
| 00 6c 00 6d 00 73 00 00 | |
| 00 88 00 00 00 00 00 00 | |
| 00 80 cf 21 b1 37 d4 c5 | |
| 01 80 79 6f e1 dc d4 c5 | |
| 01 80 cf 21 b1 37 d4 c5 | |
| 01 80 cf 21 b1 37 d4 c5 | |
| 01 d0 34 64 00 00 00 00 | |
| 00 00 00 10 00 00 00 00 | |
| 00 20 02 00 00 2a 00 00 | |
| 00 00 00 00 00 18 00 41 | |
| 00 32 00 32 00 43 00 4e | |
| 00 46 00 7e 00 59 00 2e | |
| 00 45 00 58 00 45 00 61 | |
| 00 6f 00 65 00 33 00 70 | |
| 00 61 00 74 00 63 00 68 | |
| 00 2d 00 31 00 30 00 74 | |
| 00 6f 00 31 00 30 00 31 | |
| 00 2e 00 65 00 78 00 65 | |
| 00 60 00 00 00 00 00 00 | |
| 00 80 a1 28 42 31 d5 c5 | |
| 01 80 e3 5b ef 4a d5 c5 | |
| 01 80 a1 28 42 31 d5 c5 | |
| 01 80 a1 28 42 31 d5 c5 | |
| 01 00 00 00 00 00 00 00 | |
| 00 00 00 10 00 00 00 00 | |
| 00 10 00 00 00 02 00 00 | |
| 00 00 00 00 00 00 00 00 | |
| 00 00 00 00 00 00 00 00 | |
| 00 00 00 00 00 00 00 00 | |
| 00 00 00 00 00 00 00 2e | |
| 00 7c 00 00 00 00 00 00 | |
| 00 80 70 5c 5f 2f d5 c5 | |
| 01 80 70 5c 5f 2f d5 c5 | |
| 01 80 70 5c 5f 2f d5 c5 | |
| 01 80 70 5c 5f 2f d5 c5 | |
| 01 00 00 00 00 00 00 00 | |
| 00 00 00 10 00 00 00 00 | |
| 00 10 00 00 00 1c 00 00 | |
| 00 00 00 00 00 10 00 4b | |
| 00 31 00 5a 00 36 00 51 | |
| 00 39 00 7e 00 31 00 00 | |
| 00 00 00 00 00 00 00 6b | |
| 00 65 00 79 00 72 00 69 | |
| 00 6e 00 67 00 2d 00 77 | |
| 00 57 00 59 00 45 00 73 | |
| 00 69 00 00 00 70 00 00 | |
| 00 00 00 00 00 00 3d 5a | |
| 24 2f d5 c5 01 00 3d 5a | |
| 24 2f d5 c5 01 80 d3 f2 | |
| 24 2f d5 c5 01 80 d3 f2 | |
| 24 2f d5 c5 01 00 00 00 | |
| 00 00 00 00 00 00 00 10 | |
| 00 00 00 00 00 12 00 00 | |
| 00 12 00 00 00 00 00 00 | |
| 00 10 00 5f 00 39 00 46 | |
| 00 54 00 53 00 43 00 7e | |
| 00 4f 00 00 00 00 00 00 | |
| 00 00 00 2e 00 58 00 31 | |
| 00 31 00 2d 00 75 00 6e | |
| 00 69 00 78 00 01 00 00 | |
| 00 00 00 00 00 02 00 00 | |
| 00 00 00 00 00 0a 00 00 | |
| 00 00 00 00 00 00 00 00 | |
| 80 47 81 b5 09 | end of display fragment 1 |

sending a second fragment

display fragment2:

| 00 04 e2 d7 32 9d 00 00 | |
|---|---|
| 00 21 a0 1a 08 00 45 00 | |
| 05 a8 0a a1 40 00 40 11 | |
| a7 47 c0 a8 01 08 c0 a8 | |
| 01 04 26 19 26 19 02 e3 | |
| 00 00 00 4d 00 61 00 74 | |
| 00 74 00 65 00 72 00 73 | |
| 00 2e 00 6d 00 70 00 33 | |
| 00 74 00 00 00 00 00 00 | |
| 00 00 6a 8e 79 91 cb c5 | |
| 01 00 6a 8e 79 91 cb c5 | |
| 01 00 da c3 5e 2f d5 c5 | |
| 01 00 da c3 5e 2f d5 c5 | |
| 01 00 00 00 00 00 00 00 | |
| 00 00 00 10 00 00 00 00 | |
| 00 10 00 00 00 16 00 00 | |
| 00 00 00 00 00 10 00 47 | |
| 00 34 00 37 00 4e 00 4f | |
| 00 56 00 7e 00 56 00 00 | |
| 00 00 00 00 00 00 00 67 | |
| 00 63 00 6f 00 6e 00 66 | |
| 00 64 00 2d 00 72 00 6f | |
| 00 6f 00 74 00 7c 00 00 | |
| 00 00 00 00 00 80 e2 a0 | |
| 94 75 a3 c5 01 80 e2 a0 | |
| 94 75 a3 c5 01 80 e2 a0 | |
| 94 75 a3 c5 01 80 e2 a0 | |
| 94 75 a3 c5 01 00 00 00 | |
| 00 00 00 00 00 00 00 10 | |
| 00 00 00 00 00 10 00 00 | |
| 00 1c 00 00 00 00 00 00 | |
| 00 10 00 4b 00 42 00 35 | |
| 00 43 00 34 00 31 00 7e | |
| 00 4a 00 00 00 00 00 00 | |
| 00 00 00 6b 00 65 00 79 | |
| 00 72 00 69 00 6e 00 67 | |
| 00 2d 00 77 00 32 00 37 | |
| 00 6c 00 6d 00 73 00 00 | |
| 00 88 00 00 00 00 00 00 | |
| 00 80 cf 21 b1 37 d4 c5 | |
| 01 80 79 6f e1 dc d4 c5 | |
| 01 80 cf 21 b1 37 d4 c5 | |
| 01 80 cf 21 b1 37 d4 c5 | |
| 01 d0 34 64 00 00 00 00 | |
| 00 00 00 10 00 00 00 00 | |
| 00 20 02 00 00 2a 00 00 | |
| 00 00 00 00 00 18 00 41 | |
| 00 32 00 32 00 43 00 4e | |
| 00 46 00 7e 00 59 00 2e | |
| 00 45 00 58 00 45 00 61 | |
| 00 6f 00 65 00 33 00 70 | |
| 00 61 00 74 00 63 00 68 | |
| 00 2d 00 31 00 30 00 74 | |
| 00 6f 00 31 00 30 00 31 | |
| 00 2e 00 65 00 78 00 65 | |
| 00 60 00 00 00 00 00 00 | |
| 00 80 a1 28 42 31 d5 c5 | |
| 01 80 e3 5b ef 4a d5 c5 | |
| 01 80 a1 28 42 31 d5 c5 | |
| 01 80 a1 28 42 31 d5 c5 | |
| 01 00 00 00 00 00 00 00 | |
| 00 00 00 10 00 00 00 00 | |
| 00 10 00 00 00 02 00 00 | |
| 00 00 00 00 00 00 00 00 | |
| 00 00 00 00 00 00 00 00 | |
| 00 00 00 00 00 00 00 00 | |
| 00 00 00 00 00 00 00 2e | |
| 00 7c 00 00 00 00 00 00 | |
| 00 80 70 5c 5f 2f d5 c5 | |
| 01 80 70 5c 5f 2f d5 c5 | |
| 01 80 70 5c 5f 2f d5 c5 | |
| 01 80 70 5c 5f 2f d5 c5 | |
| 01 00 00 00 00 00 00 00 | |
| 00 00 00 10 00 00 00 00 | |
| 00 10 00 00 00 1c 00 00 | |
| 00 00 00 00 00 10 00 4b | |
| 00 31 00 5a 00 36 00 51 | |
| 00 39 00 7e 00 31 00 00 | |
| 00 00 00 00 00 00 00 6b | |
| 00 65 00 79 00 72 00 69 | |
| 00 6e 00 67 00 2d 00 77 | |
| 00 57 00 59 00 45 00 73 | |
| 00 69 00 00 00 70 00 00 | |
| 00 00 00 00 00 00 3d 5a | |
| 24 2f d5 c5 01 00 3d 5a | |
| 24 2f d5 c5 01 80 d3 f2 | |
| 24 2f d5 c5 01 80 d3 f2 | |
| 24 2f d5 c5 01 00 00 00 | |
| 00 00 00 00 00 00 00 10 | |
| 00 00 00 00 00 12 00 00 | |
| 00 12 00 00 00 00 00 00 | |
| 00 10 00 5f 00 39 00 46 | |
| 00 54 00 53 00 43 00 7e | |
| 00 4f 00 00 00 00 00 00 | |
| 00 00 00 2e 00 58 00 31 | |
| 00 31 00 2d 00 75 00 6e | |
| 00 69 00 78 00 01 00 00 | |
| 00 00 00 00 00 02 00 00 | |
| 00 00 00 00 00 0a 00 00 | |
| 00 00 00 00 00 00 00 00 | |
| a0 47 81 b5 09 | end of display fragment2 |

This above fragmentation is not completed, as even though the packets are re-assembling properly, there are still cases of fragmentation not being handled properly resulting in corrupted packets being produced. This corruption is not critical in system operation however, as the client's simply have to set their MTU to 1300 in order to accommodate packets which would never need to be fragmented.

In the following output from the GateKeeper Application, the key retrieval process is shown.

GateKeeper::init( );
Pipe::init( ); 1
Conveyer:initread( ) ether src not 00:00:00:21:a0:1a and ether
src not 00:04:E2:D7:32:9C
Conveyer::initwrite( )
KeyManager initializing
Conveyer:initread( ) ether src 00:00:00:21:a0:1a
Conveyer::initwrite( )
KeyManager initializing

incomingconveyer.init( ); 1
outgoingconveyer.init( ); 1

GateKeeper::run( );
Pipe::run( );
Incoming: Detecting header
HeaderFound!
Detecting fragmentation
wnhdr[24]: 112233
failed to open file for reading 0x409fd238retrieve key from
fault
creating request: 1:2
checking response to 12
sizeof unsigned long long: 8
key was found on fault responsesize: 50
key found had UID: 69
key found had offset: 10
key found had scpcrc: 10
key found had length: 18
copying key
done copying key
key on vault
save key to drive path:
/tmp/Keys/0000000000000001/0000000000000002.key

As can be seen, the GateKeeper receives a packet, realizes it does not have the key in the local memory, or hard disk cache, and so it requests it from the Key Vault and saves it to the local cache.

In the screen output below, the rule system is illustrated. The protocol of the incoming packet is displayed (as its numeric code) and the rule as to ACCEPT/DROP/ENCRYPT is shown as well:

GateKeeper::init( );
Pipe::init( ); 1
Conveyer:initread( ) ether src not 00:00:00:21:a0:1a and ether
src not 00:04:E2:D7:32:9C
Conveyer::initwrite( )
KeyManager initializing
Conveyer:initread( ) ether src 00:00:00:21:a0:1a
Conveyer::initwrite( )
KeyManager initializing

incomingconveyer.init( ); 1
outgoingconveyer.init( ); 1

```
GateKeeper::run( );
Pipe::run( );
  $ <LPP>PMIHPDS</LPP>
================
Incoming:6 ACCEPT β here is an incoming 6/TCP packet market
to ACCEPT
$ <LPP>PMIHPDS</LPP>
+++++++++++++++++14:0:20
00 0e a6 14 1e 8e 00 00
00 21 a0 1a 08 00 45 00
00 34 df a8 40 00 40 06
d7 5e c0 a8 01 08 c0 a8
01 64 80 2a 00 8b ab 6f
9e b7 55 2a bb 33 80 10
05 b4 6a be 00 00 01 01
08 0a 00 04 7d f7 00 15
29 43
================
  OutgoingData ACCEPT βhere is an outgoing packet market as
  ACCEPT
  $ <LPP>PMIHPDS</LPP>
+++++++++++++++++0:0:20
ff ff ff ff ff ff 00 00 βhere this packet is a broadcast
packet so possibly could be filtered.
00 21 a0 1a 08 06 00 01
08 00 06 04 00 01 00 00
00 21 a0 1a c0 a8 01 08
00 00 00 00 00 00 c0 a8
01 04 00 00 00 00 00 00
00 00 00 00 00 00 00 00
00 00 00 00
================ The packet below has been marked as
ACCEPT_ENCRYPT
OutgoingData ACCEPT_ENCRYPT <LPP>PMIHPDS</LPP>
Fragmentation = FALSE CopyIP&EHeader: ChangeProtocol
ChangeSizeInIPHeader CreateUDPHeader CreateTunnelHeader
getserial( )19216818
c0a80108
getSerial: c0a80108
getserial( )19216814
c0a80104
getSerial: c0a80104
Getting key: 2:1 βHere the key has to be retrieved from
the Key Vault failed to open file for reading
0x41400a08retrieve key from fault creating request: 2:1
  $ <LPP>PMIHPDS</LPP>
+++++++++++++++++0:0:20
00 04 e2 d7 32 9c 00 0e
a6 14 1e 8e 08 06 00 01
08 00 06 04 00 02 00 0e
a6 14 1e 8e c0 a8 01 64
00 04 e2 d7 32 9c c0 a8
01 65 00 00 00 00 00 00
00 00 00 00 00 00 00 00
00 00 00 00
================
Incoming: 11 ACCEPT
checking response to 12
sizeof unsigned long long: 8
key was found on fault responsesize: 58
key found had UID: 23
key found had offset: 10
key found had scpcrc: 7318349394477056
key found had length: 825229312
copying key
```

The foregoing debugging output statements are disabled by default, but are still in the code for developers to view. These output statements are suppressed in the final system is for performance reasons.

Putting the Whitenoise tunnel header immediately after the data section of the actual packet, and encrypting the whole data section, leaving the header intact for traveling would not work since the TCP protocol has no field in its protocol header to indicate the length of the data payload. This means there is no way of detecting whether or not another header is present at the end of a packet, or whether the application on the other end could ignore the appended header. Instead the present system encapsulates the whole packet (regardless of protocol) into a new custom UDP packet, since the UDP protocol does indeed have a field that specifies how much data the payload carries, thus allowing detectable appended headers. Just using “conveyor” threads that read, process and write all at once reduces the ping times to unnoticeable (0 ms to 1 ms which are typical on a LAN). The threading model drops CPU usage to 5-7%. Also to avoid all network traffic going through the tunnel, a Berkeley Net Filter is applied on the reading of the packets that filters out the MAC address of the client system on the external network card.

With respect to the KeyVault, to avoid problems from the difference in data types sizes from different processors (e.g. a 64 Bit AMD CPU to a 32 Bit Intel CPU. In C declaring an unsigned long on a 64 Bit machine creates a 64 bit number; on the 32 bit machine the same data type declaration is compiled to a 32 bit value. This causes some issues when the two machines try to communicate.) Unsigned long longs are declared instead; this forces 64 bit data types regardless of platform.

### Installation Process

A prototype system was installed for a Linux machine using Fedora Core 4 with the full install option. Many Linux configurations by default do not allow a regular user access directly to the datalink layer for security reasons. These applications need to be run as either root or pseudo.

Requirements for a prototype system are as follows:

Minimum of 5 computers
1 computer to serve as the KeyVault (with Linux)
2 computers to serve as the GateKeepers (64-Bit AMD Arch. was used in testing)
   Configured with Linux (Fedora Core 4 used in test setup)
   Libnet libraries installed (libnet.tar.gz)
   Libpcap libraries installed (libpcap-0.9.3.tar.gz)
   QT libraries installed (included in submission as qt-x11-opensource-desktop-4.0.0.tar.gz)′
   2 network cards
2 computers to transparently use the Tunnels
   These systems may be configured with any operating system and use any applications.
   Configured to work on a local area network
   Network MTU set to 1300 Bytes in Test Setup
   Use DRTCP021.exe to set the MTU on a windows machine or do man ifconfig in linux to set the MTU
      Linux machines do not need to reboot after using ifconfig to set the MTU.

After having installed all the necessary libraries and compilers on the GateKeeper machines, the included “compile” file is set to executable (chmod +x ./compile) and execute the compile script. This will compile the included source code and inform one of any missing packages the system requires.

After having installed all the necessary compilers on the KeyVault machine and set up a “/tmp/Keys” folder, one sets the “compile” file to executable (chmod +x ./compile) and executes the compile script to compile the KeyVault for the platform it is being run on. This script will also tell one of anything else that needs to be installed.

### Configuration Process

All configuration of the GateKeeper system needs to be done in the “Include.h” file in the GateKeeper source folder.

The section:

//the ip of the keyvault server
#define KEY_VAULT_IP “192.168.1.100”//put the server IP here!
#define KEY_VAULT_PORT 1357//put the port you configured the KV as here! (and make sure your firewall allows outgoing and incoming UDP packets on this port
Needs to be modified to reflect the IP address and port being used by the KeyVault Server.

The sections:

| // GK2 | |
|---|---|
| //#define INCOMINGFILTER “ether src not 00:04:e2:d7:32:9d” | |
| //#define OUTGOINGFILTER “ether src 00:04:e2:d7:32:9d” | |
| //#define MAC 0x0004e2d7329d | |
| //#define INTERNAL_SYSTEM_IP “192.168.1.4” | |
| //#define EXTERNAL_SYSTEM_IP “192.168.1.8” | |
| //#define OUR_KEY_SERIAL | 2 |
| //#define OTHER_KEY_SERIAL | 1 |

| // GK1 | |
|---|---|
| #define INCOMINGFILTER “ether src not 00:00:00:21:a0:1a and | |
| ether src not 00:04:E2:D7:32:9C” | |
| #define OUTGOINGFILTER “ether src 00:00:00:21:a0:1a” | |
| #define MAC 0x00000021a01a | |
| #define INTERNAL_SYSTEM_IP “192.168.1.8” | |
| #define INTERNAL_SYSTEM_IP_A | {192, 168, 1, 8} |
| #define EXTERNAL_SYSTEM_IP “192.168.1.4” | |
| #define EXTERNAL_SYSTEM_IP_A | {192, 168, 1, 4} |
| #define OUR_KEY_SERIAL | 1 |

| | |
|---|---|
| #define OTHER_KEY_SERIAL | 2 |

#define EXTERNALDEVICE “eth0”
#define INTERNALDEVICE “eth1”

This needs to be modified to reflect the actual MAC addresses and IPs of the two systems that will be using the GateKeepers and not the GateKeepers themselves. The MAC of the actual GateKeeper does however need to be included in the Berkeley Packet Filter syntax found as the second MAC address in the INCOMINGFILTER definition.

In the above header file, the comment “GK1” refers to one of the clients, and “GK2” refers to the other client. One either comments out the whole “GK1” section or the whole “GK2” section.

On each GateKeeper, depending which network cable one plugs into which network card, one sets the appropriate EXTERNALDEVICE and INTERNALDEVICE. EXTERNALDEVICE is the network card that has a cable that leads to the switch/router. INTERNALDEVICE is the network card that has a cable that leads to the computer that wishes to use the tunnel.

Other options include modifying the port number for the tunnel (9753 by default, must be open on both GateKeepers' firewalls) are also in that header file, but it is not necessary to alter anything else for operation.

### Implementation Implications

There are some implications in implementing a secure tunneling system combined with the KeyVault system. Not only does the system create a secure point-to-point communications layer, but it also provides a way for dynamically adding new GateKeepers to the system without having to copy the key manually to every other client before communication can commence. At the same time it is satisfying the authentication requirement. The problem with SSH (an alternative secure tunnel system) for example, is that it is vulnerable to man-in-the-middle attacks. Distributed keys, by their very nature destroy the possibility of a MITM attack; since, an unencrypted key exchange never occurs, there is never a chance for a hacker to intercept or spoof the keys.

The Whitenoise stream cipher is particularly useful in the present invention for several reasons. It is cryptographically strong. It is a robust bit-independent encryption. The Whitenoise stream cipher provides a unique property that most other cryptography methods do not share, that is, once the data is encrypted, the bits are completely independent of one another. This is very useful when dealing with communications because often single bits will get corrupted when transferring large amount of information, and sometimes it is impossible to re-send the information, and so when the cryptography method used fails because of one bit being corrupted, then the data is lost or a huge performance hit is reached due to the necessity to resend the data. Whitenoise overcomes this issue by being bit independent. If a bit gets corrupted while being encrypted in Whitenoise, the resulting decrypted data is exactly how it would be if it were not encrypted in the first place.

The predistributed and pre-authenticated private key is used as AES session key generator thereby eliminating PKI based Trusted Third Parties for session key generation and eliminating this part of server overhead by moving it effectively to the client. Because of its highly random nature and extraordinarily long streams, Whitenoise is ideal for this purpose. Other Random Number Generators (RNGs) can be deployed, albeit less efficiently. Key generation can also occur at the server but increases unnecessarily the server overhead.

For Key Generation, the distributed keys (not session keys) are preferably all manufactured using the serial number, MAC#, NAM, or other unique identifiers as a seed in the key generation to manufacture a user/device specific key. This authenticates a device. Only the single device has the correct Universal Identifier to be able to decrypt the device/person specific distributed key with the application key (a secret key associated with the application which is never transmitted and is protected and machine-compiled within the application). This helps avoid piracy and spoofing. Thus to distribute the keys, the server will first send a serial number read utility to a new appliance as a firmware patch. The new appliance sends the MAC#, NAM or UID to the server. The server then generates unique keys and unique starting offsets from the serial number, updates itself with the UID, offset and key information, encrypts the private key with the application key and sends a package with encrypted private key(s) and secure application to the new device.

The following are various additional features of the system. Packet Authentication Pad may be added to the custom Whitenoise header. This may be used to protect against the possibility that small predictable rejection responses of a server may be blocked and intercepted by a hacker in order to reverse engineer small portions of the Whitenoise Stream. This authentication pad consists of another segment of the Whitenoise Stream interacting with Whitenoise Labs' CRC checker (which eliminates the possibility of a 100% predictable packet).

IP Fragmentation Completion may be provided. Currently the GateKeeper Tunnel Packet Fragmentation causes approximately a 1% corruption of fragmented packets. This should be corrected in the system if 100% transparency is to be maintained. This fragmentation is necessary for maintaining packets under the maximum transmission size for Ethernet of 1500 bytes. As noted above in the configuration section, MTU should be set to 1300 bytes in order to make sure that fragmentation by the tunnel never occurs.

The MAC address and IP addresses inside the tunnel may be replaced by the tunnel packet's MAC and IP in the unwrapped packet. This is necessary to ensure compatibility with subnets across the Internet, so the system will work beyond just a LAN or on an exposed Internet connection with no network address translation. A MAC to IP address binding can be added as a failsafe to double-check the authenticity and watch for attack attempts.

Implementing a KeyVault protocol to handle Key Fragmentation will allow the system to handle maximum key sizes of greater than 2¹⁶. GateKeeper registration and update management can also be incorporated. This can also be used to add IP addresses dynamically to the list of secure systems so that rules need not be created manually. A logging facility that watches for attack attempts or offset synchronization issues can be added for system administrators to identify malicious activity.

Offset Overlap Checking can be added to see if an offset is being used twice. One can compare the actual data represented by the offsets or the offsets themselves. A pad should never be used more than once, otherwise it is subject to statistical analysis attacks.

Some systems in the near future that may benefit from the DKI architecture, besides the tunnel, may include email servers/clients, and cell phones to establish secure calls in the field. Since the system relies on Berkeley packet filter type expressions to determine the types of packets read, this system can be easily integrated with firewall features.

Disabling non-encrypted traffic is an option in the GateKeeper system; however this is not practical for most environments since people need to send email outside of the company and surf the web. In some situations, as in hospitals and military, and corporate research facilities, the need for security may be great enough that the GateKeeper would drop all non-encrypted traffic.

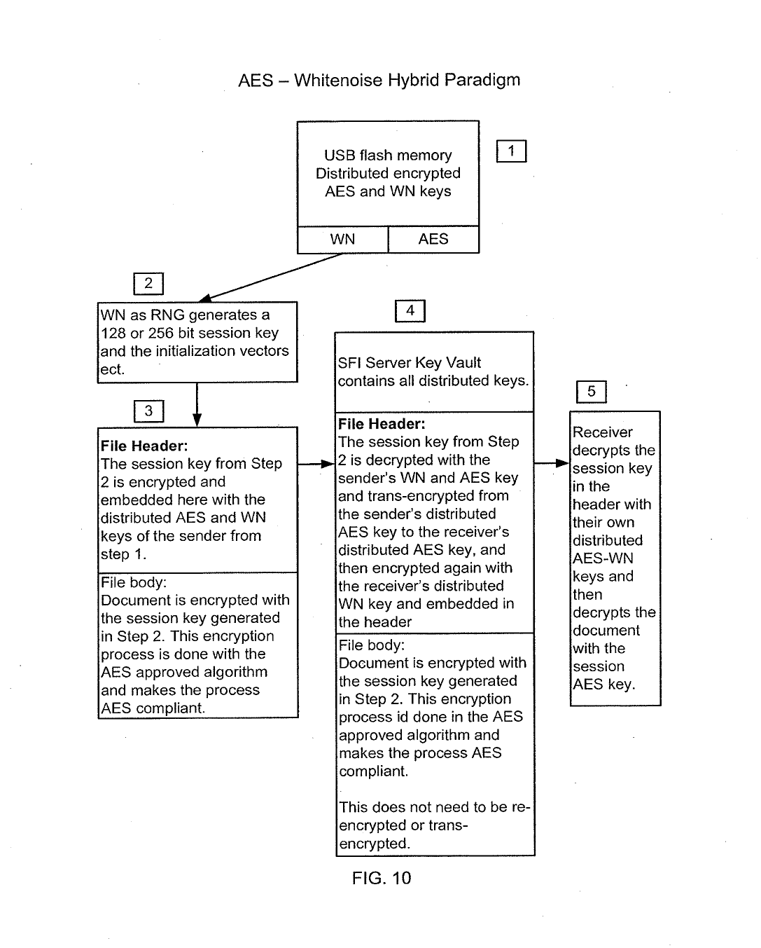

FIG. 10 illustrates the method where the predistributed and pre-authenticated private key is used as AES session key generator, thereby eliminating PKI-based Trusted Third Parties for session key generation and eliminating this part of server overhead by moving it effectively to the client. Because of its highly random nature and extraordinarily long streams, Whitenoise is useful for this purpose. Other Random Number Generators can also be used. Key generation can also occur at the server but increases unnecessarily the server overhead.

First the System administrator distributes a unique private Identity Management AES-WN (Whitenoise) key pair on a USB flash memory stick (or other media) to an employee. Alternatively, at manufacturing, devices can have a unique private key associated with a unique device identifier burned into the device during the manufacturing process.

The user is authenticated by two factors: possession of the distributed key and a robust .NET password. The two factors are something they have and something they know. The user (sender) begins by putting his distributed private AES-WN key pair in the USB drive. [In this case the distributed keys are on flash memory, smart cards etc.] He then enters his password and he is authenticated. This process has eliminated the need for a third party authentication.

To send a secure file, the distributed key acts as a random number generator and produces either a 16-byte (128-bit) or 32-byte (256-bit) session key and initialization vectors. Session keys can be any size. This session key generation is done at/by the client and this eliminates any outside Trusted Third Party for session keys. Session key generation can also be done at the server but increases overhead with the generation and secure transmission back to the client. This session key then encrypts the file using a standardized AES encryption algorithmic technique. The encryption process in this manner makes the system AES compliant.

As noted above, the distributed key may be generated specifically for a specific client by using a Universal Identifier like a MAC, serial number, or NAM of the client as a seed to make those distributed keys user/device specific and preventing piracy and spoofing. To enhance key security, when the application is initiated the application key uses the unique serial number on the device to decrypt the Private key. The application will be able to decrypt and use the private key if the serial number is correct. A pirated or copied key will be copied to another medium without the unique serial number and so the application key will be unable to decrypt the pirated private key. Files encrypted with that key cannot then be opened or used by the pirate. If a key is reported as stolen it can be immediately deactivated.

After having encrypted the file, the session key itself is encrypted (along with initialization vectors etc.) by the sender's pre-distributed AES key contained on the AES-WN distributed flash memory private keys. The AES encrypted—AES session key is then encrypted again with the Whitenoise (WN) distributed authentication key and embedded in the header of the encrypted file. WN encapsulating the AES encrypted-AES session key acts as the Identity Management authenticator and strengths the protection of the session key by adding this strong authentication. A pre-distributed pre-authenticated AES key can also do the second layer of authentication encryption.

This file is sent to the receiver via the SFI server/key vault that contains a duplicate copy of all AES-WN distributed key pairs. At the server, the server's copy of the sender's WN private key decrypts the encrypted header session key, removing the encapsulating layer of WN authentication encryption. The server trans-encrypts the session key from being encrypted in the Sender's AES key to the Receiver's AES key. This trans-encrypted session key is then encrypted with the receiver's distributed WN key, again encapsulating the encrypted session key and being the authentication layer. It is embedded in the header. The file is sent to the receiver.

The receiver is authenticated by having the matching distributed WN key and by knowing the password to activate it. The receiver is then able to decrypt the encapsulating authenticating layer. This leaves the AES encrypted-AES session key. This is decrypted with the receiver's distributed AES private key. The authenticated and decrypted session key is then used to decrypt the document or file.

The Authentication Server and Key Vault for the Dynamic Distributed Key Identity Management and data protection system as shown in FIG. 10 has a copy of all physically distributed keys and key pairs for each person/device on the system. The key pairs can be WN-WN, WN-AES, or AES-AES or any other encryption key pairs. The server may have session key generation capacity for creating new key pairs for physical distribution or for encrypted distribution in a dynamic distributed key environment; or, pre-manufactured key pairs can manually be inserted for availability by the authentication and key vault server for additional security and lower processing effort by the server. In a dynamic distributed key environment, new keys are encrypted and delivered to new nodes encrypted in keys that have already been distributed. This eliminates session key distribution using asymmetric handshaking techniques like Diffie-Hellman. Additionally, this model eliminates the need for Trusted Third Parties (outside sources) for the creation and issuance of session keys. Session key generation, when required, is preferably done by the client thereby eliminating this function as a source of increased server overhead. Session key generation may also be done by the server, or outside the server by a systems administrator.

AES session key generation is ideally done at the client preferably using a Whitenoise pre-distributed, pre-authenticated key as a robust, fast, low overhead random number generator to generate AES keys. Other random numbers generators and math libraries may be used. Dynamic distributed key architectures authenticate pre-qualified users based on something they have (pre-distributed private keys on devices, flash memory etc.) and something they know (robust password following Microsoft's “.Net2” standards for robust and secure passwords). This eliminates the dependency on third party Certificate Authorities currently required to establish identity

In dynamic distributed key architectures, the server can use its ability to trans-encrypt the secure traffic through the server from being encrypted in the key of the sender into being encrypted in the key of the receiver. Because of the speed of Whitenoise, it is possible to transcript the entire transmission (file, session keys and vectors) without negative impact on performance. A preferred alternative, to further minimize the computational overhead at the server when using either AES key pairs alone (particularly), or AES-WN key pairs, or WN-WN key pairs, is to simply trans-encrypt the double encrypted session key itself.

The trans-encryption process for session keys is as follows. An AES session key is created (preferably at the client). This session key is used to encrypt a file utilizing a standard AES algorithm. This created session key is encrypted with the client's pre-distributed AES private key. This AES encrypted session key is then double encrypted with the pre-distributed AES or WN authentication key (the other key in the distributed key pair) effectively encapsulating and double encrypting the session key and increasing by orders of magnitude the effective security and bit strength of the protection. At the server, the trans-encryption process authenticates the sender by being able to decrypt the authentication layer with a copy of the sender's distributed authentication key, then decrypting the AES session key with a copy of the sender's distributed AES key, then re-encrypting the session key with a copy of the receiver's predistributed AES private key, and finally encrypting all of the above with a copy of the receiver's predistributed authentication key. The double encrypted session key is then embedded in the header of the file and the file is forwarded to the recipient.

While this is a four-step trans-encryption process, server processing is minimal because only the AES (or WN) session key is trans-encrypted. For example: a 128-bit AES session key is 16 characters or bytes long. The entire trans-encryption process is only manipulating a total of (16 bytes×4 steps) 64 bytes. This is negligible even for strong AES keys. It ensures robust security by strong protection of the session key (never transmitted unencrypted electronically) with minimal server processing.

This process improves Identity Management and data protection in contexts where governments or enterprises are encumbered by having to use existing AES standards even though these standards have proven to be ineffective and of questionable security. It allows immediate compliance with existing standards while facilitating the gradual transition to stronger encryption and authentication algorithms and techniques.

### Double Private Keys

A two token system or double private key system can also be used. Each endpoint creates their own Private Key by an adequate method (RNG, robust pass-phrases, use of sub key schedule etc.). There is no key transmission, just initial starting key history (token). Client and endpoints all create their own keys. This provides reduced storage, as there is just previous the history (token), offset and key structure. To initiate the process the use of a secure channel, like SSL, is required. This prevents Man-in-the-Middle. First computer A XORs their first token (starting from a random offset only they know) with the shared secret and sends to B. B XORs their first token (starting from a random offset only they know) with the shared secret and sends to A. Each end point has authenticated the other. Each endpoint has a starting key history of the other. Each endpoint has generated their own initial offset that no other party knows (an additional secret). Each endpoint has generated their own private key (their secret) and they have never shared it or transmitted it. A creates a token using their own token history sender THs [generated from their own private key and secret offset] and XORs with the token history of the receiver THr [the actual chunk of data received at last session]. Each endpoint has the last token history (the actual chunk of history data) of the other endpoint that was transmitted the previous session; each endpoint has their own offset and secret private key that has never been transmitted.

| Sender s | Receiver r |
|---|---|
| Ps = Private key of the sender | Pr = Private key of the |
| | receiver |
| THs = token history sender | THr = token history of |
| | the receiver |

The token history of the sender THs is always generated from their secret offset and private key. The token history of the receiver THr is always the actual data block (token) received from the Sender in the previous session.
Sender: THr XOR THs=this session token
Receiver: decodes using THr that he generates.
   Receiver has authenticated sender.
   Receiver uses and then retains THs for next time
      And vice versa if desired (doubling)

There is thus a dynamic between offset and actual token history (data block). One authenticates without the private keys ever being transmitted back and forth. Each endpoint does not need to store their own token history (actually preferable not to) because they can regenerate the last token history for their private key and current offset by going backwards on the key one session volume (length of a session TH component). If someone captures a token history (actual data block) they can determine the sender's private key or offset. If someone captures an offset, they can determine the token history (data block) because they don't have the private key.

### Ongoing Identity Authentication Component

The present system manages the identity of users by 1) initially ensuring that the individual accessing the system is who they say they are, by referencing the last point in the key reached during the last session with the same user. The system stores the point in the Whitenoise stream cypher where the previous session for that user stopped and compares the starting point of the stream cypher at the start of the next session for that user; 2) verifying the user's identity throughout the session; 3) ensuring that a duplicate key is not in existence; and 4) defending the network if an intruder is detected by denying access to both users. The reported loss or theft of a key results in instantaneous denial of access.

The process provides meaningful and highly differentiated authentication and detection features. The critical insight here is that as content is being consumed, so is the WNkey being consumed. An aspect of the interaction between two end-points is therefore the index into the WNkey. This value is not likely to be known by third parties. Even if the WNkey was stolen, or were the corresponding key structure compromised along with knowledge of the WNL algorithm, ongoing use of the WNkey to gain unauthorized access to protected data would not be possible without the index value corresponding to the authorized history of use between legitimate correspondents. This continuous authentication and detection feature is called Dynamic Identity Verification and Authentication [DIVA]. The DIVA sings only for the correct audience. Not only will illegitimate users of the WNkey be denied, but the legitimate users will immediately and automatically benefit from knowledge of the attack and attempted unauthorized use: the WNkey does not need to be explicitly revoked; it will simply become unusable to its legitimate owner. This can also be accomplished using other non-Whitenoise algorithms that produce long deterministic random (or pseudorandom) data streams or by invoking iterations or serialization of those outputs.

In the process of ongoing real-time continuous authentication, referred to as Dynamic Identity Verification and Authentication, an unused portion of the key stream is used in a non-cryptographic sense. A chunk of random data from the key (or Random Number Generator) and its offset are periodically sent during the session to the server and compared against the same string generated at the server to make sure they are identical and in sync. This random chunk (unused for encryption) can be held in memory and compared immediately, or written back to media like a USB or a card with write-back capacity for comparison in the future. This segment has never been used and is random so there is no way for a hacker to guess or anticipate this portion of the stream. The unused section of keys stream that is used simply for comparison between server and the client can be contiguous (next section of the key used after encryption), random location jumping forward, or a sample of data drawn according to a function applied to the unused portion of key stream. Whitenoise is deterministic which means that although it is the most random data source identified, two endpoints can regenerate the identical random stream if they have the same key structure and offsets.

There is currently no standard or effective protocol for the enumeration and ongoing presence detection of external USB devices and components from a server through a client's computer to determine its presence for authentication of physically based removable keys like USB flash drives, memory cards and sticks, smart cards etc. Reliable presence determination is critical to prevent spoofing and other security breaching techniques. It is important to be able to check identifiers like MAC numbers and serial numbers (as well as any other unique identifiers) for both initial and ongoing authentication of the client. This is one factor in multi-factor authentication (something you have and something you know).

An example of a preferred ongoing USB device/appliance authentication technique is offset overlap checking. In this context it is the offsets being compared to one another. Example:

Client Side:

1) offset is set to 100

2) encrypt data A of size 200, and increment offset by 200

3) send the data

4) offset is now set to 300

5) encrypt data B of size 300, and increment offset by 300

6) offset is now set to 600

Server Side:

1) because of network congestion data B arrives before data A

2) server recognizes that the offset is way ahead, but that is acceptable, because this stream has never been used.

3) data A arrives, server recognizes there may be an issue because the offset used is lower than the highest offset used so far

4) server checks for overlap: 100+200=300, 300+300=600, no overlap!

An example where overlap does indeed occur, is where data A is encrypted at offset 100 with a size of 100, then data B is encrypted at offset 150 with a size of 100. 100 to 200 overlaps with 150 to 250 from the offset 150 to 200 (50 bytes overlap) which would signal that someone is attempting to tamper with the system.

Modified or alternative USB presence techniques that can be effectively used include sending bits of key stream up to the server to authenticate and make sure that the offsets are in sync and identical with the bits and offsets of the identical key pairs of the client at the server. MAC Numbers, serial numbers and other unique identifiers can be used as well. It can be programmed to occur whenever an action takes place. Offsets can be incremented to reflect and bypass the bits used for ongoing session authentication so that these bits of keys stream are never repeated and used.

A similar process can be used with credit cards. The difference is that one is actually transferring a random segment of data and both the server and the client (smart card) are actually updated with a 1 kilobyte segment of data. After a successful comparison of the same chunks of data, the process sets up for the next transaction or continuous authentication by copying back a fresh segment of data from the next unused segment of the key stream. The difference is like opposite sides of a coin—one side just checks the offsets that are saved, and the other side actually checks the data represented by those offsets e.g. offset 1222285 plus the next 1 k. Then one increments by 1 to set the next offset for the next segment of random data used for verification. This can be called as often as desired.

A database has the users' demographic information, such as the account number, an offset value and a key reference that points to WhiteNoise. For example, a user is making a purchase with his smart card. A smart card has a unique account number which is also stored in the database. On this account, there are several credit cards, for example, Visa, Master and American Express. For each credit card on the smart card, there is a 1k segment of random data corresponding to it.

The transaction is carried out as follows. The smart card is swiped in step 1. The user is asked to enter his password in step 2. If the password is valid, the smart card number pulls up the user's entire information in the database in step 3. The information includes demographic information, an offset value and a key reference. At the same time, 1k segment of data is uploaded from the smart card to some place on the server. After being pulled up from database, the offset value and the key reference are loaded to WhiteNoise in order to generate 1024 bytes random data. (step 5). Once the 1k random data are generated, they are stored on the server. (step 6) Then the 1k data generated by WhiteNoise in step 6 and the 1k data uploaded from smart card in step 3 are compared. (step 7) If they are matched, then a transaction starts. Otherwise, the transaction is denied. (step 8) After the transaction is done, the offset value is incremented up 1024 bytes. The database is updated with the new offset value. Also, the balance on the credit card needs to be updated. (step 10) At the same time, the new offset value and key file are sent back to the WhiteNoise to generate new segments of random data. Starting at the position pointed to by the new offset, a new 1024 bytes random data are picked. (step 11) The new 1k chunk of data is then sent back to USB chip and overwrites the old 1k chunk of data. (step 12) It is now ready for the next transaction.

A dynamic distributed key system preferably uses a robust password (something they know). It is not uncommon for users to forget or lose their passwords and their retrieval is necessary for the ongoing use of this Identity Management paradigm so that users can continue to be authenticated and able to retrieve encrypted information or files. There are two primary techniques for password recovery while maintaining anonymity of the users. 1) At time of system initiation and use, a user registers their key without personal demographics but rather by the use of several generic questions and answers that are secret to the user. The server can then re-authenticate and securely re-distribute this password in the future if necessary. 2) The user accesses secure applications and services with a unique distributed key, an application key and a generic password. The users change their passwords. Their new password is then encrypted with the application/private key and stored safely on a user's device/computer or removable device. In the event a password is forgotten, the encrypted password can be sent to the server and the user is re-authenticated, and the server can re-issue another default password for that user associated with their physically distributed private key. This would be sent in an encrypted state to the user.

### A Perturbing Method of Key Creation

Key creation, storage and distribution are always important considerations in creating secure systems that protect data and manage identities. Whitenoise keys are multifunctional. One aspect of them is that they are very efficient deterministic stream random number generators. With just the knowledge of the internal key structure, and offsets, two end points can recreate the identical stream segment (token). In a distributed key system, each end point has pre-distributed key(s). Without transmitting key information, and just transmitting offsets, each end point can recreate the identical key segment (token) that has never yet been created or transmitted. As such, these authenticating key segments cannot be guessed or broken by interlopers. Capturing authenticating tokens are not a sufficient crib to be able to break the actual key of which they are simply a tiny bit-independent segment.

Whitenoise keys are the preferred method to accomplish this because key storage space, computational overhead, and the size of footprint on both the server and client devices are minimized. A small amount of internal key information and offset generates enormous highly random key streams and minimizes storage requirements for long keys for each person or device on the network. Key distribution happens in one of several of ways:
The key(s) are physically given to the client/server
The distributed keys are manufactured (burned or branded) onto a device using a device Universal Identifying number like a MAC #, serial number, NAM (cell phones) to associate a key to a specific device to combat piracy of the key
A distributed key is associated with a specific device and electronically returned to the device or person encrypted in an application key for readily scalable secure networks or identity management schemes.
A generic application key schedule that all endpoints have is “perturbed” to create a unique user/device specific key by the secure exchange of a session key that is used with an algorithmic key schedule to create a unique deterministic key for use by the endpoints. This abstraction technique means that the key used by the endpoints is never transmitted. An algorithmic key schedule is a series of sub-key structures populated with random bits.

An example of a perturbing method of key generation is as follows:

### Key Generation Technique

The Key K is the session key transmitted by a secure method. The

Sub-Keys SK₁ . . . SKₙ are an algorithmic key schedule that has been pre-distributed to the endpoints. Each endpoint and the server have an identical algorithmic key schedule that is comprised of n sub-keys of various lengths populated with randomized bits. Key schedules can be modified from application-to-application. A virtually endless array of different key schedules may be used to add higher levels of variability between different applications. The server sends endpoint A the session key K by a secure process (SSL, Diffie-Helman etc.). Offsets are independent of key creation. For encryption use, the offset is managed by the application to prevent re-use of key segments. For identity management, detection and the use of DIVA, the offset is determined by process or formula from the distributed key K values. For example, break a 128-bit (16 byte) key K into 8 2-byte segments and XOR these segments to create a compressed/reduced offset value.

i) Starting at the offset P, XOR the corresponding bits of the session key K and Sub-Key 1 (SK₁) until the sub-key is completely processed
ii) After SK₁ is perturbed, shift to the right and beginning at P-1 SK₂ is processed in the same fashion until completed
iii) After SK₂ is perturbed, shift to the right and beginning at P-2 SK₃ is processed in the same fashion until completed
iv) Repeat until all SKᵥ keys are perturbed in this fashion.

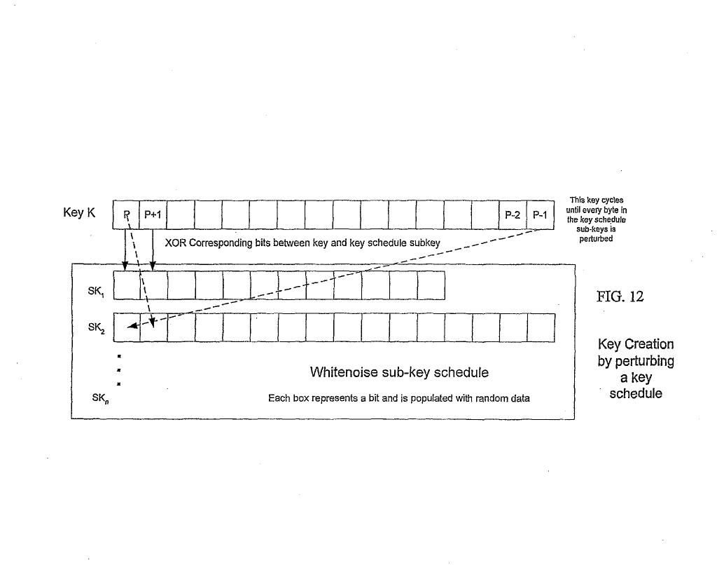

A unique Whitenoise key from a transmitted session key K by perturbing the sub-key structure schedule has been created. The key stream that will be used is created by XOR'ing corresponding bits of SK₁ through SKₙ (vertically) starting at a different offset. See FIG. 12 for the key generation process. A performance result from this process is the ability to create enormous, highly-random key streams while minimizing the footprint/storage required on the device or endpoint. It also minimizes the amount of key information K that needs to be transmitted to the smaller sized key lengths in use today.

In this fashion sub-keys have been perturbed to create keys that cannot be guessed or broken while giving Whitenoise keys the same size or similar sized footprint of other crypto or key options. Each implementation can have a unique key schedule. The key schedule has then been perturbed to a unique Whitenoise implementation and is ready for use. This has accomplished several things. Man-in-the-Middle can have the distributed key schedule but is never privy to the offsets or the session key that in turn generates the unique endpoint key. This technique also simplifies manufacturing and storage issues (for example in SCADA environments) and is still able to generate unique keys.

### Universal Identifier Perturbing Key Creation Method

(With and without Password)

There will be contexts where the end users will find a balance between the use of dongle based keys (external peripheral devices like USB flash memory or similar RSA authentication dongles) and not requiring the user/end point to have an extra physical device. In this context, a key schedule on a device/end point can be perturbed to create a unique key with unique key stream output by using a device/end point specific identifier like a MAC or NAM number. That number is read, modified if desired by running it through a one-way function, and this result is used to perturb a device/end point key schedule, in the manner explained above, to create a device specific key with additional layers of abstraction. Additionally, at devices or end points where there is human interaction, this technique can also deploy the use of a password (the private key is known only to the user) and the universal identifier number to then perturb the key schedule. Note that endpoints and servers must use secure key exchange methods to distribute these keys to other endpoints and each other for communications. Note that while the use of a password might be the weakest security link if robust passwords are not used, any security concerns are mitigated against by the use of DIVA and its continuous authentication and detection abilities.

Method of Eliminating the Use of Passwords and the Inherent Problem with Passwords

The use of passwords as an authentication factor is ubiquitous. Reliance on passwords creates a fundamental security problem and it also creates a fundamental human user problem with network and application access because of what is generally regarded as a universal aggravation.

It is common to see multi-factor authentication where User Names and Passwords are used in conjunction with another authentication factor like keys. A technique to create unique private keys and avoid the problems that are inherent in secure key transfer or distribution in asymmetric or public key architectures is to use a password that the end user chooses and to use this password to perturb or interact with another key or authentication factor to create a unique private key known only by the end user.

As a technical security reality, in this context, it becomes irrelevant how strong the other authentication factors are because the strength of 10 keys is only as strong as the weakest link, or factor, involved in that process. So, as an example, let us say a system uses a key that is 1026 bits in strength and in some manner it is dependent upon the password chosen by the end user to allow an end user to create their own private key. If a user chooses a weak password like their name then the actual strength of the private key to resist cryptanalysis is the strength of the password chosen.

To illustrate, say a system uses a 1028 bit key and the end user chooses a password like their name, in this case Sandra. The name Sandra is six characters long or 48 bits. In this context, the actual strength of the resultant private key is 48 bits and not 1028 bits.

It is now generally recommended that users choose robust passwords that contain an upper and lower case letter, a number, and a keyboard character, for instance, Sandra1&. People have trouble remembering passwords, and their prevalent use means that most computer users have to remember multiple passwords for different services. As a result, it is typical that computer users write their passwords down and save these files on their computer, or tape them to the back of their computer or under their keyboards, under their desks etc. These become freely accessible to criminals. Additionally, people use bad passwords like “password.”

Use of Whitenoise exponential keys of extraordinary length, and the ability to manage offsets or indexes into the resultant key stream, means that it is possible to eliminate the use of passwords altogether and exploit the characteristics of a single distributed key.

A method of using a single, distributed key residing at a server and never given to the client or endpoint for protection of credit cards, debit cards and financial transactions and logs page is provided. Financial transactions of all kinds are continually under attack. Credit and debit card numbers, passwords, PIN numbers, subscriptions and other kinds of bank related data are continually hacked. Additionally, person's give out important password and PIN numbers to friends and family to use their cards and they are later victimized by people they trust.

This method describes a way of using Whitenoise keys, and DIVA in DDKI systems so that a client or cardholder etc. is provided a key by the bank or service provider and yet never has knowledge of that key itself so it can never be given away, copied, or stolen. Dynamic identity verification and authentication (DIVA) as described previously exploits the ability to manage offsets into extraordinarily large key streams to create a one time pad and eliminate any in session key or offset exchange.

Offsets are an index into these deterministic random key streams and in process, a token of arbitrary length, beginning at the valid offset is created for comparison. In this method, the token itself (and not the offset) is used for transactions.

The server, in this case a bank, has a unique key structure assigned for every account. The single key resides at the server under the control of the bank or service provider and is never given out. The card is DIVA enabled electronically by writing a token (the actual random data) to the chip, magnetic strip etc. When a transaction is conducted, the last valid token (which is what the last valid token at the server represents and which it is able to recreate beginning at the last valid offset) is sent to the server along with the account number, card number or any other unique client/device identifier.

The server creates a token of the same length for this client/device/transaction beginning at its last valid offset. The server compares the endpoints token to the token it has just created. If they are identical, the server:

1. sends an authorization for the authenticated transaction without sending key or offset information.
2. the transaction is conducted
3. the server, which is the only party with a copy of the distributed key, generates another token, beginning at its next valid dynamic offset and sends this token to the endpoint to be written by the card/device ready for the next transaction.
4. the server saves the new next dynamic offset for the next transaction to be able to recreate an anticipated token for next authentication request and the session is ended.

Use of the token itself as opposed to the offset which it represents is secure because the token is random (and therefore functionally encrypted), it is unguessable or unbreakable because the key stream and DIVA operate as a one-time-pad, and because any token itself can never provide enough key stream material from key streams in excess of 10 to the 60th power bytes in length to be used cryptanalytically.

Use of both this technique, as well as other DIVA configurations, can effectively be used for credit card fraud, debit card fraud, money stealing from banks and online. Additionally these techniques can be used to prevent and monitor other banking frauds by creating unalterable logs in order to prevent insider trading, identity theft, rogue trading etc.

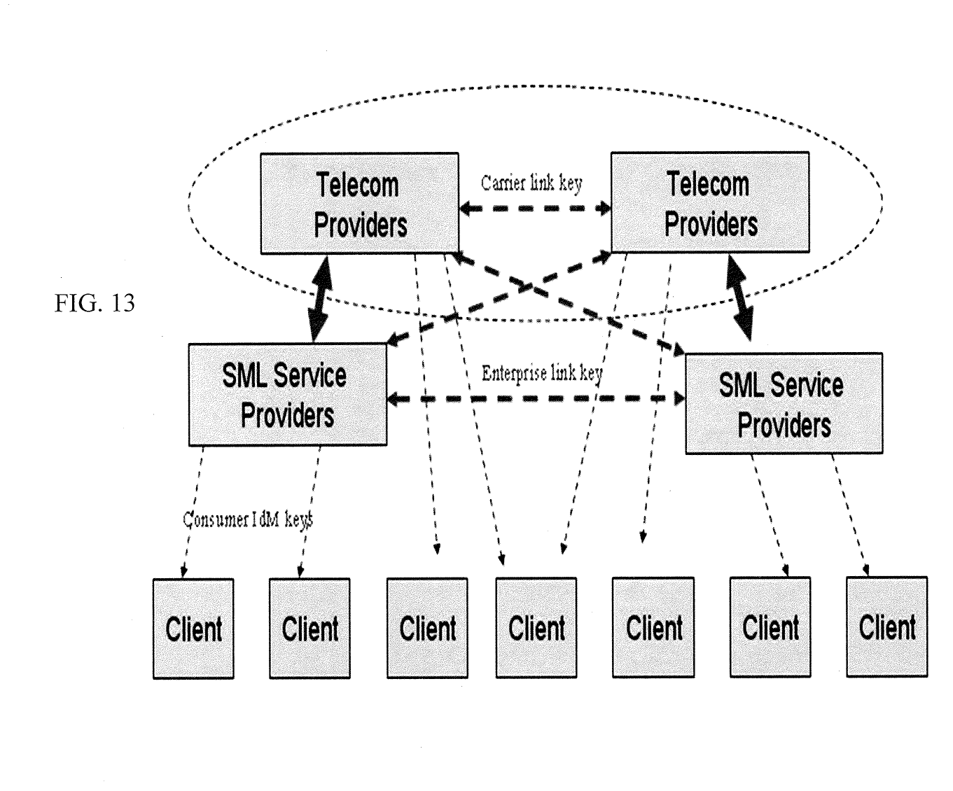

Dynamic Distributed Key Infrastructures (DDKI) frameworks are tiered, hierarchical, secure, network-of-networks of persons, devices, servers and networks of dynamic identity verification and authentication (DIVA) enabled communicants. Master Keys (which create an infinite number of unique Identity Management keys) can be distributed to telecommunication and service providers. See FIG. 13. Master Keys can be distributed directly to telecommunication providers following regulatory protocols. Carriers create their own keys internally. Carriers in turn can provide keys to service providers, enterprises and consumers (subkeys of the master key). Enterprises create keys internally for their own employees or clients. Link keys between carriers and between enterprises create a secure network-of-networks necessary for vast area communication architectures.

This tiered distribution approach facilitates secure networks while balancing privacy and legitimate law enforcement needs. It does not require any asymmetrical key creation or asymmetrical key (PKI) key distribution techniques.

### Dynamic Identity Verification and Authorization [DIVA]

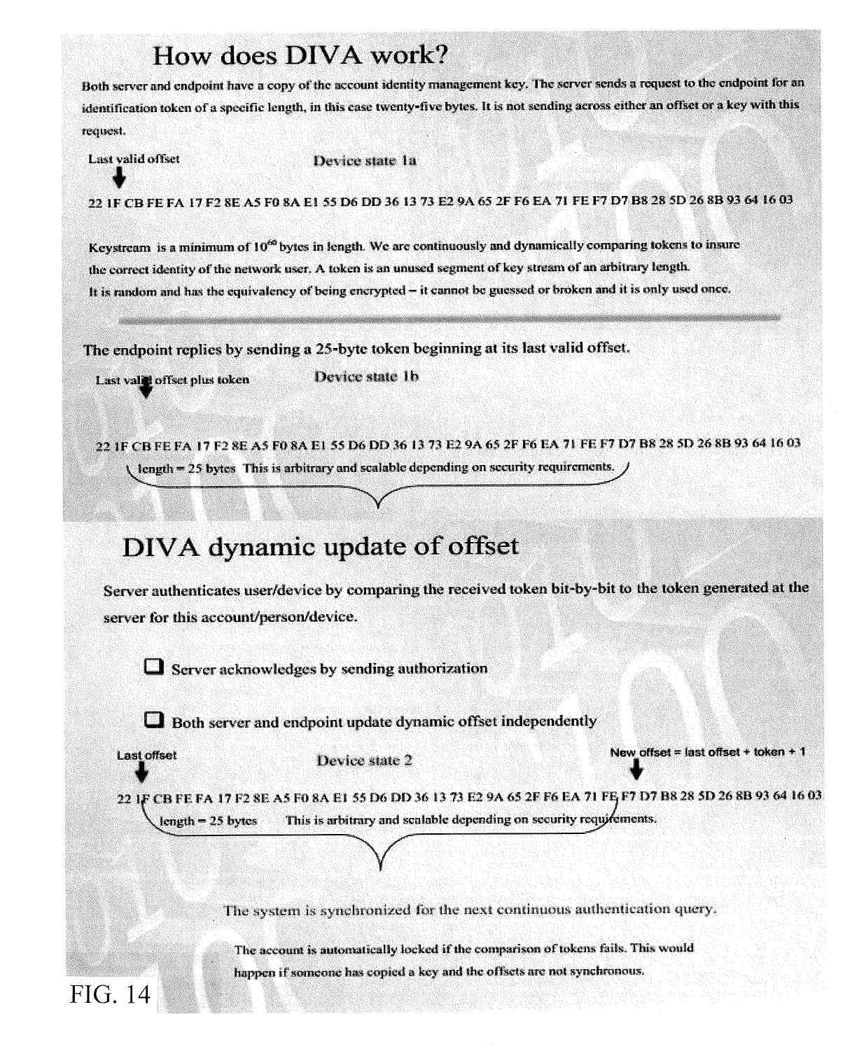

As shown in FIG. 14 the fundamental characteristic of Dynamic Identity Verification and Authorization and the different security functions it enables is the ability to generate and compare tokens (key segments) that have never yet been created or transmitted without the transmission of either key or offset information during a session. These and other similar DIVA techniques are ideal for identity verification, network access/use, continuous and dynamic authentication, inherent intrusion detection, automatic revocation, history logging, deniability or non-repudiation and works in any digital context or topology like Internet based secure payment topologies, secure cloud topologies, secure site access, SCADA topologies, smart grids etc. (but not restricted to these).

The server and the endpoint have an identical copy of the DIVA identity management exponential key structure that has been pre-authenticated and pre-distributed. It is used in a fashion that embeds characteristics of a one-time pad. The server sends a request to the endpoint device/person to identity itself. Neither an offset nor key is sent with this authentication request. The endpoint device (computer, USB, phone, mobile, SCADA component etc.) responds by sending the server a token of variable length beginning at the endpoint's last valid offset. This token is functionally secured for this transmission because it is random (like encryption should be) or according to current accepted belief highly pseudo-random, because it has never been used before, and because it is only used once. (One can send that token across an SSL connection for additional two channel/factor authentication protection but this is not requisite.) The server receives the token and generates a comparable token from its last valid offset for that account. It compares the tokens bit-by-bit and if they are identical the endpoint is authenticated.

The server acknowledges this and sends an authorization to continue. Neither an offset nor key is sent with this authorization. The endpoint and server update their offsets independently by advancing the offset by the length of the last token plus one (or some other agreed function.) The system is synchronized for the next request. If comparison fails, non-synchronicity of offsets and keys is inherently detected and revocation is automatic without human intervention.

Key structures and initial offsets are generated by the system. The endpoint requires about 20k of memory/storage. Key creation utilities can be provided with a permit, otherwise keys are provisioned online or at the point of manufacturing. The product interface for person entities is familiar to consumers i.e. user name and password with DIVA operating in the background. DIVA operates inherently in conjunction with any other authentication like an optical scan or any application. Additionally, the use of passwords is problematic because users have trouble remembering, and therefore using, appropriate passwords. Additionally, passwords can be used but pushed to operate in the background, embedded within an application or device, so that human users do not have to remember them.

This invention can be used with any device on any kind of communications network like wireless, mobile, broadband, internet, etc. Devices only require connectivity, storage and write back capacity. The protocol is started at network access and continues to do dynamic authentication throughout a network session. In many contexts, it can operate without an interface (just inherently) i.e. machine-to-machine communications, SCADA, etc.

### Dynamic Distributed Key Infrastructures (DDKI)

Dynamic Distributed Key Infrastructures are tiered, hierarchical software frameworks associating devices/endpoints (i.e. servers, phones, accounts) that deploy DIVA. This can be used in conjunction with any other security technique, framework, topology, network type, etc. DIVA/DDKI can be used in any digital context and with any digital device with communication, write-back and a little storage space (for the offsets and IdM key structures). They can run in parallel to public key systems; they can be integrated into public key systems; they can be used in lieu of public key systems. It is easily integrated into larger systems and easily used in conjunction with any network or internet backbones. Examples include: Secure Session Manager which provides secure network access and identity management. This can be implemented at point of network login or at the point of any application access. When DIVA and DDKI is deployed by a carrier hundreds of millions of consumers can be easily protected by having a single call to a DIVA routine from the single-sign on login procedure. Authentication servers and databases that are either inside their own firewalls and perimeters or are provided by 3^{rd} parties. It is easily integrated into any application, any network login protocol or any communication protocol. As such, as an algorithm, DIVA can piggy-back into any context, or into any software application or microprocessor without significant additional cost as a firmware or software upgrade. For instance, as the world upgrades to IPv6 because there are not enough unique internet addresses globally it would be easy to distribute keys for DIVA and DDKI simultaneously to provide complete network and identity security. Or, conversely, for those that are slow to adopt IPv6, the use of DIVA will mitigate the security risk attendant with redundant IP addresses since the DIVA keys and offsets would be unique.

DIVA provides certificateless authentication and identity management where there is only partial disclosure of credentials that eliminates man-in-the-middle and side channel attack classes. DIVA encompasses the following abilities:

### Stateful Two-Way and One-Way Authentication

Two-way authentication means that each endpoint can request and send authenticating segments of data or offsets. This means that each endpoint has key generation capability. One-way authentication means that only one endpoint (server/site) has key generation capacity. The server then makes a request for a token from the endpoint. (In the case of securing data in the cloud this paradigm is flipped and an endpoint can request a token from the server.) The endpoint replies by sending a token it received at the end of the last authentication call and delivers it securely to the server. This token has the equivalency of being encrypted because of the extraordinary degree of randomness from these kinds of keys and because of its one-time-pad characteristics. The server/site compares the token received from the endpoint to the data or token it generates using the endpoint's key structure and current valid offset for its unique account and key. If they are identical then the transaction is authorized and the server generates the next token to be used beginning at its last valid offset (the offset at the end of the transaction for that key) and sends it to the endpoint to replace its last dynamic token. When this is used for financial transactions like credit cards it means that the client cannot give away their key, nor can it be stolen, because the key does not reside at the endpoint.

Currently, authentication of a network user occurs once at login. When an interloper hacks into a “secure” network, the interloper is free to roam around unnoticed because there is no effective identity management and real-time intrusion detection. With DIVA, the key stream is polled throughout the session to continually identify and verify that the correct user is on the network. It is possible, but not necessary, to incorporate creation and transmission of session keys, use of time stamps and other identifiers or authentication factors etc. to increase the security of initial network access (login) and then DIVA continues to authenticate from there.

### Stateful Detection

The offsets of the key streams must remain in sync between the endpoint and the server. If an interloper manages to steal a key and gain network access, then the offsets between the server, the legitimate endpoint, and the interloper become out of sync. There are only two outcomes:

1) The legitimate owner uses his key/card first and the offset (or segment of random key data it represents) is updated on the legitimate endpoint. When the thief then uses the stolen key/card it won't process because the offset (or data segment it represents) does not match between the stolen key/card/device and the server. The account is immediately disabled.
2) The thief uses the stolen key/credit card/device first successfully. The next time the legitimate user tries to access the network or uses their key/card/device the transaction is refused because the stolen key has been updated with a new offset or segment of data, the offset on the server database has been updated, but not the segment of data or offset on the legitimate key. Theft or illegal access has been identified. The account is immediately disabled. Where any possible theft occurred is known because of the previous transaction or associated IP address. All suspect events are known beginning at the time where the legitimate account was in synch and ending at the time the account was locked.

### Automatic Revocation

The inherent intrusion detection is simply continuing to monitor that offsets and key segments (tokens) always remain in sync. This is a simple comparison of offset numbers or sections of random data. Without any human intervention, the instant out-of-sync offsets are detected then the account is frozen and that key is denied network access. It does not require going to outside parties, revocation lists etc. A system administrator can remediate or deal with any situation without worry of continued or ongoing malfeasance

### Authorization/DRM

The assignment and monitoring of permissions and usage rights are accomplished by using different portions of the key stream in the same fashion as authentication.

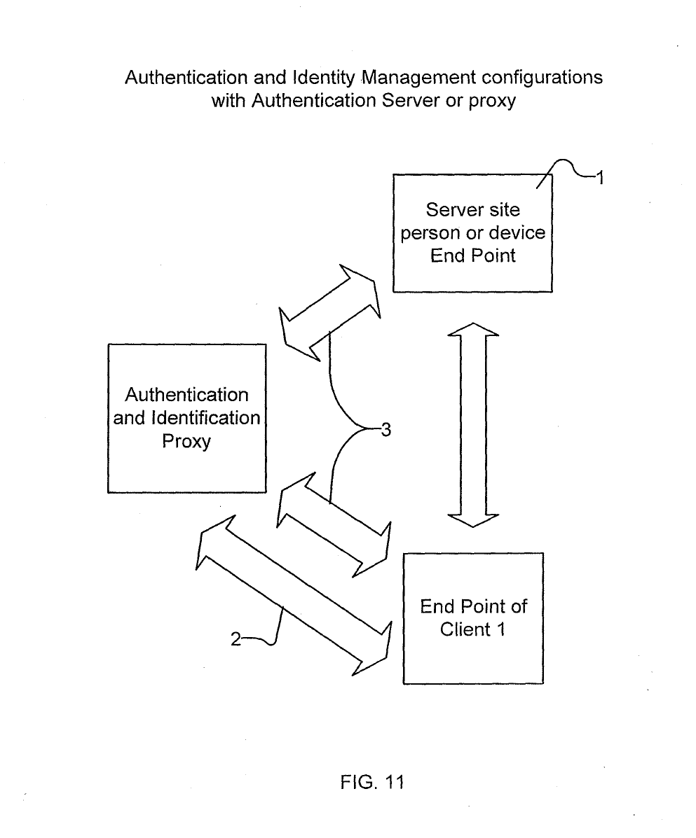

FIG. 11 is a schematic illustration of the authentication and identity management configurations. In peer-to-peer authentication 1, each end point is pre-authenticated first by the physical distribution of their key to them or they are authenticated through a proxy authentication server first. Communications then become point-to-point. Each endpoint can generate or store their own key segments for comparison; each side can poll the other end point by requesting unique key segments (tokens) or offsets for comparison. Each end point manages keys and offsets. All management is offloaded to the peers. In proxy and/or un-trusted third party authentication server 2, an endpoint can key generate to authenticate and track their own usage history with a proxy. If the DIVA is always in use, this configuration gives the endpoint (client 1) verified authentication, and deniability or repudiation capability by logging information, corresponding usage or access to a third party (in this instance the server or site endpoint). Authentication is only in one direction. It is possible to configure the proxy to be an Un-Trusted Third Party. This proxy would manage offsets and not be privy to user key information. This means that if their database is hacked that there is no key information about network users available. In two way authentication with proxy authentication server 3, each endpoint can generate or store their own key segments for DIVA comparison; any endpoint can poll the other endpoints or the authentication server proxy by requesting unique key segments (tokens) or offsets for comparison. An alternate configuration is that the authentication server does all the polling of the endpoints and completely manages the offsets and the authentication process.

### Prevention of Man-in-the-Middle Attacks (Hybrid and Otherwise)

The above techniques prevent Man-in-the-Middle attacks because there is no key or offset transfer during a session. Additionally, the security of the one-time, on-line, initial distributed key distribution can be augmented by using legacy PKI or other secure distribution mechanisms to create a two channel, both symmetric and asymmetric multi factor authentication and key transfer of which Man-in-the-Middle is unaware of or not privy to. This, however, is not requisite because keys are never distributed in an unencrypted state. Dynamic Identity Verification and Authentication may also prevent Man-in-the-Middle attacks without the need for exchanging such a key and/or offset, or without using PKI/SSL/Diffie-Helman to transmit key or offset information. This is because regardless of whatever information may be captured by the Man-in-the-Middle (MiM), he does not have the correct physical key of the user or device. If MiM has the physical stolen key then the endpoint being compromised does not have a key to get on the system (so it is not Man-in-the-Middle attack). If there is a physical loss of a key, the theft/loss is reported and the systems administrator disables the account. If the unique key information was copied onto a different device, the key will not function because the correct universal identifier, device identifier or system key that is required to decrypt and use the key is not available. And still assuming that the MiM interloper can get on the system, this presence will be identified and dealt with by DIVA because two identical keys with different (out of sync) offsets would be detected and disabled.

A Man-in-the-Middle attack presumes that endpoints A and B are on the system simultaneously and that the interloper C is capturing transmitted information and redirecting it whereby C pretends to endpoint A that he is B, and pretends to endpoint B that he is A. In a unilateral DIVA deployment where just the end-point, or the client and the proxy, have the DIVA key, the interloper C can bypass A and B (be outside the system) to hack into a website or server, and directly steal login, key, and other security metrics. They can then login into the site as a different person/device. This is a different kind of security hole that needs to be addressed by other means such as firewalls, intrusion detection, storage of encrypted user information etc. or for the server/site itself to adopt using DIVA and creating a two-way authentication relationship between server/site and the endpoint/client. Such an attack approach is not a Man-in-the-Middle attack but it would be identified and dealt with nonetheless by DIVA.

In the above scenario the DIVA users have deniability (repudiation) of a purchase or activity on a site because there is no logged activity for such a situation on their DIVA key or on a proxy monitoring such activity. The breach is still identified and deniability or repudiation for the client is established.

### Prevention of Side Channel Attack Classes (Hybrid and Otherwise)

Side Channel attack classes map physical data to create a crib in order to use cryptanalytic techniques to break a key. For example—a computer controls electricity transmission. Fluctuations in that transmission are mapped as a crib in an attempt to break the key of the computer or device controlling the process. Using a Whitenoise or exponential key in these processes has been proven to be Side Channel attack resistant because after key load all operations of DIVA (all functions including encryption) are order one operations. This means that the only other possible available material to the hacker, outputted ciphertext, is a flat line with no fluctuations or variations in the stream. As such, Side Channel attacks are reduced to being brute force attacks or trying every possibility which is not feasible on these kinds of keys that easily create key streams greater than ten to the sixtieth power bytes long. Again, no key information is transmitted or available in this context.

Although this is the case in software deployments, it is anticipated that the best deployment of DIVA keys is in microprocessors that provide a secure, convenient method of distributing identity and security inherently within a communicative device or component. Side Channel attack classes try to exploit physical realities like leakage, electromagnetism, radiation etc. but DIVA can prevent that.

### Prevention of Botnet Attack Classes (Hybrid and Otherwise)

Botnets are rogue networks that are designed to hide their identities and location in order to commit criminal activity. They do so by commandeering other computers, servers or devices. Generally, a piece of malware which commandeers control of another computer infects a computer to make it part of the botnet. The infection with malware generally occurs by exploiting flaws in browsers, email, and other communication processes.

Once a computer is infected and becomes part of the botnet, we must assume that the malware has access to all information on the commandeered computer or device including any keys used for security. And it appears to be legitimate by assuming that device/user's identity. And, for any harm to be done by the malware, stolen information (or spam) from the infected computer/devices needs to be sent out from the infected computer. This would be information like passwords, credit card numbers, or virtually any other kind of information. And that malware needs to either exploit the infected computer's communications or set up an entirely parallel communication ability from the infected computer.

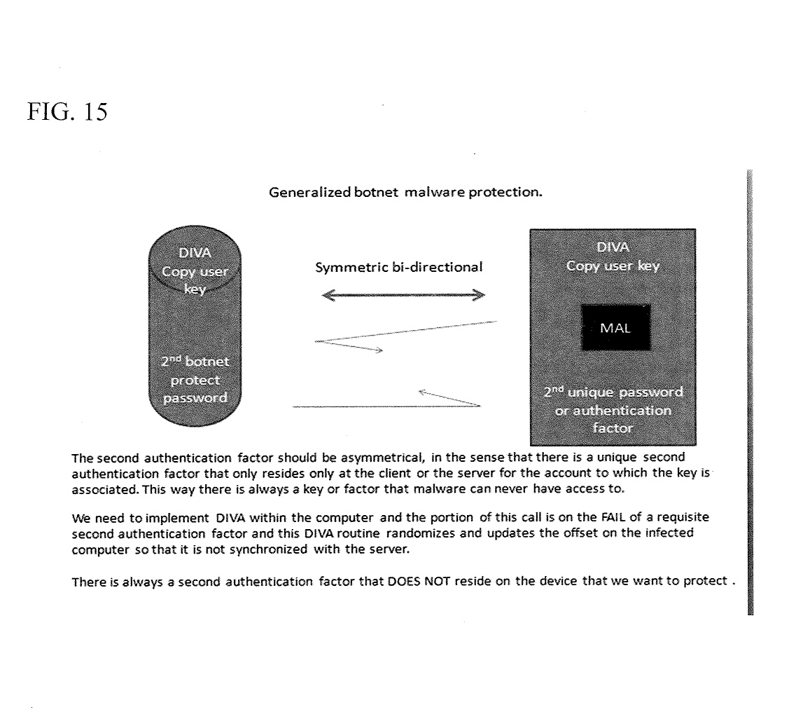

To address this, the paradigm changes from using DIVA to authenticate all information or access coming into a computer to also configuring DIVA to authenticate all information leaving a computer (to make sure it has not been commandeered.) With reference to FIG. 15, prevention of botnet malware malfeasance requires a DIVA symmetrical key which both endpoints have and which we have to assume that the malware can commandeer, and two unique private passwords or second authentication factors of which the server has one and of which the end point has the other. Each of these second factors is unknown to the other party in a client-server paradigm. Since we need to authenticate information leaving an infected computer that computer needs a portion of the DIVA routine that can update dynamic offsets for the key that is residing on the infected computer. And finally, it needs a call for the other endpoint's “botnet net protection authentication factor (i.e. like a password).”

For example, the botnet malware tries to send stolen information out of an infected device. Since it is accessing communications the system requires entering a password or a call to a second non-resident authentication factor. Since that password resides at the server and not the infected endpoint the malware has no access to the password. When the malware fails at this part of the routine the internal DIVA component is called and updates the offset that resides on the infected computer (if that key is not removable) and ensures that the offsets are out of synch with the copy of the same key at the server and ensures that outbound communications are prevented by automatic revocation of network access.

If a communication attempt is in some way forced, either by a human user or by the malware, then the server recognizes the offsets are out of sync and locks the account. The malware has not succeeded in recruiting the infected device into the botnet and no stolen information was transmitted (or spam sent.) If the malware tries to attach hidden data to a legitimate transmission going out of an infected computer, a simple cyclical redundancy check or hash function or alternate technique that compares the size of the anticipated file being sent and the difference in file size created by a malware attempting to attach unauthorized or intended data. The system administrator can then deal with the infected computer without concerns for harm.

### Mitigating False Positives and False Negatives Generated by Biometric, Heuristic and Behavioral Authentication Techniques

No biometric, heuristic and behavioral authentication can ever be completely accurate. Higher accuracy requires comparing more coordinates. Better cameras and other physical components drive up the cost of the handsets and other devices. Use of DIVA for mobile authentication allows greater security with one-time-pad dynamic authentication while lowering the number of coordinates to compare. It solves all of the problems attendant with deploying suitable identity management and provenance for mobile devices with no net increase in cost.

DIVA deterministically randomizes a dynamic set of coordinates to compare for each biometric authentication. The number of compared coordinates can be reduced. Security increases because it is operating as a one time pad. No changes of existing hardware components are required on any device. False positives or false negatives from a biometric do not create a security risk because DIVA is the default authentication factor and is 100% accurate.

Creating Session Keys at an Endpoint and Using Session Keys without any Asymmetric or PKI Key Creation or any Asymmetric or PKI Key Distribution Technique

The invention provides a dynamic distributed key system and his is an example of a context that uses a distributed key to create session keys without any asymmetric key creation or any asymmetric key negotiation or key exchange process. This invention is for DIVA distributed systems where all endpoints have a unique distributed key and only the authentication server has an identical copy of a unique account distributed key.

In this process the distributed key of the sender is used as a random number generator to create a session key. This session key is then used with a resident, standardized encryption module. The information to be sent is encrypted with the session key. The sender's distributed private key then is used to encrypt the session key that was just used, this encrypted session key is embedded in a header and the encrypted key and encrypted file are sent to the authentication server.

The server is able to decrypt the session key because it has an identical copy of the sender's distributed key. After, it then uses the decrypted session key to decrypt the encrypted data or can in turn re-encrypt the session key with an intended receiver's distributed key, and both the encrypted file and secure session key are forwarded to the receiver. This technique reduces overhead because only the session key is being decrypted and then re-encrypted and this is a small amount of data. The encryption of the messaging has already been accomplished at the sending endpoint.

Tunneling and Creating a Session Key at a Server without any Asymmetric or PKI Key Creation or any Asymmetric or PKI Key Distribution Technique and Using this Session Key with an Endpoint that DOES NOT have a Copy of the Sender's Distributed Key (The Recipient is not an Authentication Key Server.)

Traditionally distributed key systems require that a key be delivered through courier or in person to each person with whom one wishes to establish a secure link. This invention is another means to overcome this encumbrance. At any time, ne can start communicating to someone else that uses the invention without having to wait for a distributed session key to be delivered. The advantage of this paradigm is that the server never has to handle or forward the encrypted messaging/file thereby further reducing the overhead at the server.

This embodiment of the invention therefore provides a method of encrypting and securing a communication between a first source computer A (sender) and a second destination computer B (receiver) wherein the source A (sender) and destination computers B have each been provided respectively with their own unique pre-authenticated and pre-distributed keys or key structures, each associated with their own unique private distributed key identifier, wherein a key storage server has copies of the first and second private distributed keys (the private keys for both A and B as well as copies of all the keys on the system), each associated with the first and second unique private key identifiers (the private key identifiers for both A and B), the method comprising, in this instance, that the authentication server creates the session key as opposed to the endpoint (sender) creating the session key (as we previously saw) and

i) the source computer (sender) sending a request to the key storage authentication server for a session key;
ii) the key storage server identifying the source computer and locating its associated private distributed key;
iii) the key storage server generating a unique session key from its unique, distributed master key for the session in question, identified by a unique session identifier;
iv) the key storage server encrypting the session key with the source computer's private distributed key and sending it, with a session identifier, to the source computer;
v) the source computer (sender) using the source computer private distributed key to decrypt the session key and using the session key to encrypt the communication, which is sent to the destination computer (receiver) directly along with the session identifier;
vi) the destination computer (receiver) receives the encrypted communication and session identifier and sending a request to the key storage server for the session key associated with the session identifier session offset;
vii) the key storage server determining from the session identifier or offset whether it has or can create the corresponding session key, and whether it has the destination computer's (receiver's) private distributed key;
viii) if the key storage server determines from the session identifier that it has the corresponding session key (or offset from which to recreate the session key from the master key), and has the destination computer's private distributed key, the key storage server encrypting the session key with said destination computer's private distributed key and communicating it to the destination computer;
ix) the destination computer (receiver) then decrypting the session key using its private distributed key and decrypting the communication using the decrypted session key.

The GateKeeper and the KeyVault work together to create a dynamic distributed key environment for TCP/UDP tunneling. The Gatekeeper creates and encrypts tunnels based on simple standard netfilter rules, while the KeyVault facilitates the retrieval of point-to-point keys as required by GateKeepers as they talk to each other.

In short, the system currently facilitates near-transparent, dynamic, encrypted point-to-point communication between networks on a network. The KeyVault and GateKeeper systems work together to create a layer on any IP based network, like the Internet, that allows communications to remain secure and confidential.

### Continuous, Dynamic, Certificateless Authorization DIVA Technology

The server and the endpoint have a copy of the key that embeds characteristics of a one-time pad. The server sends a request to the endpoint device/person to identity itself. Neither an offset nor key is sent. The server receives the token and generates a comparable token from its last valid offset for that account. It compares the tokens bit-by-bit and if they are identical the endpoint is authenticated. The server acknowledges this and sends an authorization to continue. Neither an offset nor key is sent. The endpoint and server update their offsets independently by advancing the offset by the length of the last token plus one. The system is synchronized for the next request. The number and speed of calls for authentication are configurable. If comparison fails, revocation is automatic without human intervention.

### Authorization

When a DIVA authentication passes, the system returns an authorization allowing the secure network session to continue. The authorization says okay only and it does NOT send any key or offset material to the endpoint with this authorization. Both the endpoint and the server automatically and independently update the dynamic offset for this key and account by a predetermined formula such as updating the current dynamic offset by the length of the last token plus one. In this manner the endpoint is safely authorized after authentication and the next dynamic offset for the next authentication call indexes a part of the key stream that has never been used or created.

### Intrusion Detection

Both the endpoint and the server are independently tracking the dynamic offsets and their synchronicity for the account. The dynamic offsets, and the tokens they define, must be identical at both the server and the endpoint. If they are not identical this indicates that someone has stolen or copied a key and has accessed the account and the network, or that such an unauthorized attempt has been made. When the comparison of offsets or tokens fails the account is automatically locked. The system detects failure either because the offsets are different, the resulting tokens are different, or both. This is inherent, stateful intrusion detection because the system is either synchronized or not and no human intervention is required.

### Signature

A specific static, deterministic portion of a private, distributed symmetric key can be used as a simple but secure signature. Keys are pre-distributed and pre-authenticated before key distribution so the key itself is the unique identifier for an account, user or endpoint. As small portion of this identity based cipher can serve as an effective and simple signature and can be represented by one offset or token that remains static.

### Revocation

When the system is not synchronized and an account is locked, it is performing revocation without the asymmetric system requirement of needing to go to an outside revocation list to prevent someone from accessing the network. The revocation is the resulting state of a failed authentication and lack of synchronicity in the system.

### Repudiation

Each key distributed is unique, pre-distributed and pre-authenticated and therefore is an identity based key (in the same way that DNA is a unique identifier for each individual.) Because the system logs all network use, i.e. who or what accessed the network and what the network was used for, the unique key or a determined segment or subset of the key stream and its equivalency to a signature acts as an effective receipt for a repudiation-non repudiation security control.

### Digital Rights Management

Digital rights management security controls are accomplished with this system by using a uniquely encrypted media for a specific endpoint or user from their private key. A session key can be created by the endpoint distributed private key and sent to the media server. The media server uses this unique, identity based session key from the endpoint unique distributed key in conjunction with a media key used for encryption. This additional media key has also been pre-authenticated and pre-distributed at the time of the enrollment of the device. The encrypted media is then sent from the media server back to the endpoint with or without the session key depending on the additional security deployed like SSL. The endpoint can then decrypt and access the media with its copy of the session key (token) associated with the uniquely encrypted media. Only the intended, pre-authenticated and pre-authorized receiver can then access a particular media file.

### Online Enrolment

Provisioning keys electronically requires online key distribution and enrollment which is the association of an account, key and an account identity. This culminates in the activation of the key when these processes are successfully completed. In this manner the system facilitates secure service.

In a preferred method of operation this system will have a request from an external endpoint. The server will either read a unique device identifier like a MAC number or serial number, or the endpoint will send unique device identifiers to the server or the server can brand a unique identifier. The server will then generate a unique private key for the device using the unique private identifiers either as sub keys or as seeds in order to generate a unique, device specific key. It will then pre-distribute this key by sending it to the endpoint becoming enrolled.

Pre-authentication of this endpoint and key will include confirmation of the correct serial numbers and unique identifiers on the device, as well as any other authentication and identity proofing processes desired. Once the endpoint or endpoint user is pre-authenticated, the system authenticates that it is the correct device by comparison of unique identifiers; the device/person/key is activated and allowed secure network access.

Identity proofing is the authentication of a person (or private key owner) with a particular device, key, or service and locking in this association. An example would be handing an individual an identity card in person where the person and the photograph of the person on the identification are together at the same location at the same time for visual verification of identity. Different levels of identity proofing may require the physical presence of an endpoint device or user in order to authenticate. The requirement of different kinds of additional authentication factors is usually a function of the security levels required or desired for a particular process or service. Keys can also be pre-distributed at time of manufacturing by associating a unique pre-distributed key with a device or microprocessor which is part of the device being provisioned.

### Side Channel

It is a preferred method to use symmetric keys constructed in a manner in which after key load all operations utilize the X-OR function. The X-Or function on a computer is the fastest operation available and it is an order 1 operation. Side Channel attacks require that physical characteristics of things that are controlled by computers, like energy distribution, or physical output from computer components like radiation, are mapped. The mapped physical data is then compared to cipher text digital output to determine correlating patterns. Side Channel attacks are prevented because all operations after key load are order 1 operations and there are no variations in computation patterns or digital cipher text output to be used to generate a crib, to break a key or to identify where to align mapped physical output against exponentially long key streams or cipher text. Additionally there is no key transfer in use.

### Botnets

A preferred method to configure the system is to require that all data leaving a network must have authentication from a link key, at the server level, to authenticate traffic between network servers. A Botnet is a security problem where malware is planted on an unsuspecting computer with the intent of commandeering it. The goals are to steal data from an infected computer and to send the data out to a Botnet server which effectively remains unidentified or appears to be sent by the commandeered computer even though the sender has not been authenticated and authorized and the receiving server has not been authenticated and authorized.

While the assumption must be made that Botnet malware that has commandeered an external computer or end point has access to all information on that device including keys (encrypted or not) it is also assumed that a Botnet server which is collecting stolen information does not want to identify itself to a targeted network server which houses the infected Botnet commandeered computer. The Botnet malware does not have any access to a server link key and the Botnet server does not have access to this key as well. As such any unauthenticated and unauthorized outbound traffic will be revoked at the server level and the logs will indicate which computers within that network attempted this in order to identify potentially infected devices within the network.

The system is configured where outbound data is authenticated with its legitimate server by use of a unique identifier and/or unique token that resides only on the server in a unidirectional authentication call. The server level keys are inaccessible to Botnet software that has been introduced on an endpoint device. A manual outbound authentication call requiring the presence of a user and a device sending data out of a network can also be configured into the system to require additional authentication so that Botnet operations cannot occur surreptitiously in the background.

### Cloud and Controlling Life of Data

Cloud computing means that data is stored or computed outside of a self contained network or device. The “cloud” does not imply that data is locationless but rather there is a service provider outside of a network, on another network, that is considered to be a trusted third party. Data is residing or applications and services are being invoked at a location outside one's own computer or network. This leads to a follow up problem of how to eliminate or control one's own private data when it resides on another computer providing an application or service. It is problematic to gain access to a service provider computer in order to eliminate one's personal data that is residing in the “cloud” and controlling its potentially unlimited lifespan or availability.

If a private key is located anywhere outside of the device sending data into the cloud, the process cannot be considered secure. If an endpoint device is configured to unilaterally perform authentications and encryption of data for recipients outside of the network (cloud) and there is never a copy of the private key at any service providers outside of the sender's network, then the cloud computing will be safe.

A preferred method of this invention is to implement it in a fashion where an endpoint or network is capable of providing endpoint unidirectional authentication and robust endpoint encryption. This enables data to be authenticated and encrypted before sending the data into the cloud. It addresses the problem of the unlimited life of data in the cloud or on the internet because while the personal data is not deleted, it is inaccessible or unusable or unreadable to anyone outside because there are no private keys for these files or data residing outside of the owner network. The private keys are required to decrypt and use this data.

In this method, a DIVA provisioned endpoint is configured to request authentication of the target server and perform encryption on the data in question. In this approach, at the end of the last session, instead of both the endpoint and the server independently updating their last valid offset, the endpoint will generate the token to be used for the next session from the endpoint's last valid dynamic offset and send the token itself to the server providing the cloud data storage or service. This results in a system where a cloud server never has a copy of a private key but it retains the ability of authenticating with the endpoint that has initiated the request for network access to retrieve data stored outside of its own network or to use this data outside of the network. When an external service is discontinued, the private data is unusable to any external and unauthorized parties even if that data has not been destroyed because they have no copy of the key associated with the encrypted data or the last authentication token the endpoint has.

Reversing this process so that the server unilaterally authenticates an endpoint which only has an offset (to compare token histories) or the token for the next authentication call and the server has the copy of the private key and the current dynamic offset is the preferred configuration of this system for processes like authenticating and authorizing credit cards. An additional value to this system design for credit cards etc. is that the endpoint user is never in a position to give away his private key and the private key is not available if the card or device is physically stolen by a criminal.

### Quantum Computing Attacks

Quantum computing entails using physics based techniques to exponentially increase processing speeds and to provide stateful intrusion detection. Regardless of their efficacy quantum encryption still requires the most robust random number generator available. One of the outcomes of quantum computing will be that many problems that were previously considered to be NOT problems and effectively unsolvable by current computing techniques will become solvable. When quantum computing is applied to breaking and stealing cryptographic keys, simple brute force techniques that test every possible key combination or solution will become effective. The sheer computational speeds attendant with quantum computing will solve a fixed problem with a fixed number of variables easily. Current cryptosystems rely on fixed key sizes and are therefore vulnerable.

The preferred cryptographic keys used for this system are distinguished in part in that every variable is variable and the system does not rely on fixed key sizes. As such, quantum computing attacks will be resisted because the system can use variable key sizes and therefore in essence will create a functionally infinite number of problems which need to be solved. This dulls or thwarts any attack scenarios enhanced by virtually limitless computational speeds.

### Two Channel Authentication

A preferred method of system use is to require both DIVA authentication for the pre-authorized, pre-distributed symmetric key but to also utilize asymmetric authentication techniques that are prevalent through Secure Socket Layers and other public key technologies that are generally present on today's networks. When the two different approaches are used together in an authentication routine then any attempts to break these keys must be able to break a distributed key and a public key or asymmetric authentication routine simultaneously even though they are fundamentally different approaches. This adds an addition level of cryptanalytic complexity and a security system approach that can be thought of as two-channel authentication distinguishing the different, combined authentication approaches as well as its multi-factor authentication approach.

### Managing Offsets and Using Token Histories

The system can also store and manage the actual tokens that are defined by dynamic offsets. Said another way, the server can manage keys, accounts, users and endpoints as well as last current dynamic offsets and/or the actual tokens the indexes define. It compares dynamic offsets and tokens that are deterministically generated beginning at a particular last valid dynamic offset. It accomplishes this comparison without private key or offset exchange after initial key provisioning. In a common use, upon request, an endpoint generates and sends a token to the server that generates it own token of the same length for this account starting at its last valid offset. The server then compares the received token with its own generated token and compares the two bit by bit to make sure they are identical before authentication is determined and authorization is given.

The system can compare tokens generated from particular dynamic offsets. The current dynamic offset refers to the index locating the starting position in the key stream to create a token of predetermined length using a forward portion of the key stream that has never yet been used. The system can compare token histories by comparing the actual stored offsets as an authentication factor or they can compare the actual tokens generated beginning at these offsets. Or the system can compare both depending on need and configuration.

### Preferred Symmetric Key Construct

The preferred kind of keys that the system uses are symmetric keys that generate enormous, exponentially-long key streams by X/Or'ing corresponding bits between a predetermined number of sub keys that comprise the symmetric key structure. These kinds of keys have the following kinds of characteristics:

The generated key streams are of enormous lengths which are so long that different portions of the same key stream can be used for any key based security control without requiring a different distributed private key. The starting point of any token is the last stored dynamic offset. Multiple dynamic offsets can be used on the same key stream simultaneously for use as different kinds of security controls.

There are many well documented kinds of key based network security controls and they include but are not limited to authentication, authorization, intrusion detection, signature, revocation, repudiation, and digital rights management. This system enables a single distributed symmetric key to invoke dynamic, continuous and certificateless authentication as well as any other key based network security controls with the same one-time provisioned private key.

Combining DIVA with biometrics is one preferred method that eliminates the need to remember passwords altogether. For example, biometrics can be combined with this authentication method and system to associate organic identity with the digital identity management key for identity proofing. The changing dynamic offsets and resulting tokens act like one time passwords that don't have to be remembered by a user. Use of the biometrics in conjunction with the key eliminates the need for passwords because they always have the additional private key or identifier with them. Passwords are often one of the weaker security links in network access because people don't want to remember robust passwords (and many different ones.) A person cannot remember their iris or fingerprint and yet it is there so the need to remember passwords is eliminated.

### Criminals

The purpose of this system is to prevent unauthenticated, unauthorized access to a network or data which is a criminal behavior. The offsets of the key streams must remain in sync between the endpoint and the server and therefore this stateful intrusion detection has only two outcomes:

1. The legitimate owner uses his key first (while a criminal is trying to break their key) and the offset is updated independently at both the server and the legitimate endpoint and the criminal must start all over in his criminal attempts each time an authentication occurs.
2. Theoretically it must be considered that a criminal can steal or break a key, and spoof a specific device, and break any other additional authentication factors in a multi-authentication factor scheme and log into the network successfully. The next time the legitimate key tries to access the network or uses their key/card/device the transaction is refused because the stolen key has been updated with a new offset or segment of data, the offset on the server database has been updated, but the correct offset or segment of data on the legitimate key has not been updated. The server recognizes that the legitimate key is no longer synchronized with the expected offset at the server and unauthorized access has been identified. The account is immediately disabled. Where unauthorized network access and possible theft has occurred is known because of the previous transaction and its associated IP address. All suspect events are known beginning at the time where the legitimate key was in sync with the server and ending at the time the account was locked.

In addition to the exemplary aspects and embodiments described above, further aspects and embodiments will become apparent by reference to the drawings and by study of the following detailed descriptions.

While a number of exemplary aspects and embodiments have been discussed above, those of skill in the art will recognize certain modifications, permutations, additions and sub-combinations thereof. It is therefore intended that the invention includes all such modifications, permutations, additions and sub-combinations as are within their true spirit and scope. There are many obvious topological configurations possible by changing where the different components of key creation and storage, authentication, detection and revocation occur between a client, server, person, device or a proxy. Individual components may be used in other network topologies for additional layers of security abstraction.

What is claimed is:

1. A method of sending a secure encrypted communication between a first source computer and a second destination computer, comprising the following steps:
i) providing said source and destination computers each with an identical copy of a unique pre-distributed symmetric key and a first valid offset;
ii) said source computer sending a request to the destination computer to identity itself, without sending either an offset or a key with said authentication request;
iii) said destination computer responding by sending the source computer a random or highly pseudo-random, previously unused token of variable length from the pre-distributed key beginning at the destination computer's last valid offset;
iv) the source computer receiving said token and generating the corresponding token from its last valid offset for the corresponding key in respect of the destination computer;
v) said source computer compares the two tokens bit-by-bit and if they are identical, authenticating the destination computer, and if they are not identical, cancelling the session;
vi) if the source computer finds the tokens to be identical, the source computer sending an authorization to said destination computer to continue, without including an offset or key with said authorization;
vii) said source and destination computers updating their offsets independently by advancing the offset by the length of the last token and a number calculated by a predetermined function;
viii) a first one of said source or destination computer sending a communication to the other one of said destination or source computers respectively, encrypted by said pre-distributed key and said other one of said source or destination computers decrypting said communication using said pre-distributed key;
ix) repeating steps ii) through viii) for subsequent communications between said source computer and said destination computer.

2. The method of claim 1 wherein said pre-distributed symmetric key is exponential.

3. The method of claim 1 wherein said pre-distributed symmetric key is created by extremely long deterministic key streams.

4. The method of claim 1 wherein said pre-distributed symmetric key is a deterministic, random key stream of extraordinary length.

5. The method of claim 1 wherein there is no asymmetric or PKI key distribution.

6. The method of claim 1 wherein said source computer has copies of all pre-distributed keys for all the destination computers on a given network.

7. The method of claim 1 wherein there is no subsequent transfer of key or offset information in a network session.

8. The method of claim 1 wherein there is no subsequent transfer of a password in a network session.

9. The method of claim 1 wherein all operations after key pre-distribution are order 1 operations.

10. The method of claim 1 wherein only the source and destination computers have a copy of the unique pre-distributed key.

11. The method of claim 6 wherein the source computer requires only a single unique pre-distributed key for each destination computer in said network.

12. The method of claim 1 wherein said pre-determined function is addition.

13. The method of claim 1 wherein multiple offsets are used simultaneously.

14. The method of claim 1 wherein the destination computer XORs the first token starting from a random offset with the pre-distributed key and sends the result to the source computer in response to the authentication request,

15. A system for sending a secure encrypted communication between a first source computer and a second destination computer, wherein said source and destination computers are each provided with and have stored in data storage respectively an identical copy of a unique pre-distributed symmetric key and a first valid offset, said system further comprising
i) communication means associated with said source computer for sending a request to said destination computer to identity itself, without sending either an offset or a key with said authentication request;
ii) processing and communication means associated with said destination computer to respond by sending the source computer a random or highly pseudo-random, previously unused token of variable length from the pre-distributed key beginning at the destination computer's last valid offset;
iv) processing means associated with the source computer for a) receiving said token and generating the corresponding token from its last valid offset for the corresponding key in respect of the destination computer; b) said source computer comparing the two tokens bit-by-bit and if they are identical, authenticating the destination computer, and if they are not identical, cancelling the session; c) if the source computer finds the tokens to be identical, the source computer sending an authorization to said destination computer to continue, without including an offset or key with said authorization;
v) processing means associated with said source and destination computers to update their offsets independently by advancing the offset by the length of the last token and a number calculated by a predetermined function;
viii) encryption processing means associated with a first one of said source or destination computer for sending a communication to the other one of said destination or source computers respectively, encrypted by said pre-distributed key and for said other one of said source or destination computers to decrypting said communication using said pre-distributed key;
whereby subsequent communications repeat the foregoing steps in the communications between said source computer and said destination computer.

16.
